(19) United States
(12) Patent Application Publication
(10) Pub. No.: US 2025/0390198 A1
(43) Pub. Date: Dec. 25, 2025

(54) TECHNIQUES FOR PRESENTING AUGMENTED-REALITY CONTENT IN MULTIPLE PRESENTATION MODES BASED ON REAL-WORLD CONTEXT, AND DEVICES, SYSTEMS, AND METHODS THEREOF

(71) Applicant: Meta Platforms Technologies, LLC, Menlo Park, CA (US)

(72) Inventors: Hayden Schoen, Evanston, IL (US); Christopher Anderson, Brooklyn, NY (US); Rahul Arora, McAllen, TX (US); Nathan Aschenbach, Seattle, WA (US); Pol Pla I Conesa, Portland, OR (US); Luke O'Connor, Toronto (CA); Jenna Velez, Seattle, WA (US); Israel Pastrana Vicente, The Woodlands, TX (US); Shengzhi Wu, Belmont, CA (US)

(21) Appl. No.: 19/244,940

(22) Filed: Jun. 20, 2025

Related U.S. Application Data
(60) Provisional application No. 63/662,872, filed on Jun. 21, 2024.
(60) Provisional application No. 63/755,987, filed on Feb. 7, 2025.

(51) Int. Cl. G06F 3/04815

(52) U.S. Cl. CPC G06F 3/04815

(57) ABSTRACT

A method of determining an AR UI to present of a plurality of AR UIs is described. The method includes, in response to an indication to present user-interactable content via an augmented-reality (AR) headset, selecting an AR user interface (UI) of a plurality of AR UIs for presenting user-interactable content. The method includes, in accordance with a determination, based on sensor data obtained by the AR headset, that the AR headset satisfies a movement dwell threshold time, presenting the user-interactable content in a user-position based AR UI of the plurality of AR UI. And the method includes, in accordance with another determination, distinct from the determination, based on other sensor data obtained by the AR headset, that the AR headset satisfies a movement threshold, presenting the user-interactable content in a user-motion based AR UI of a plurality of AR UIs.

### RELATED APPLICATIONS

This application claims priority to U.S. Prov. App. No. 63/755,987, filed on Feb. 7, 2025, and entitled “Techniques for Presenting Augmented-Reality Content in Multiple Presentation Modes Based on Real-World Context, and Devices, Systems, and Methods thereof”; and U.S. Prov. App. No. 63/662,872, filed on Jun. 21, 2024, and entitled “Techniques for Presenting Augmented-Reality Content in Multiple Presentation Modes Based on Real-World Context, and Devices, Systems, and Methods thereof,” each of which is incorporated herein by reference.

### TECHNICAL FIELD

This relates generally to user interfaces for (augmented-reality) AR devices, including but not limited to adjusting between a user-position based AR UI and a user-motion based AR UI based on whether sensor data obtained by an AR headset satisfies a movement threshold.

### BACKGROUND

Users interact with user interfaces of devices while they are in various contexts (e.g., while sitting at a desk, walking down a street), and different presentations of the user interfaces are advantageous for different contexts. For example, a user may prefer to interact with a user interface via a laptop or desktop computer while they are sitting at a desk, and in contrast may prefer to interact with the same content via a mobile device and/or AR headset while they are standing and/or moving around.

Further, users may be interacting with user interfaces while they are performing an activity that causes them to change their direction of focus, but the users may wish for the user interface(s) that they are interacting with to maintain a consistent position within their field of view (e.g., in a particular position with respect to the user's gaze direction, and/or a direction that their head is facing).

As such, there is a need to address one or more of the above-identified challenges. A brief summary of solutions to the issues noted above is described below.

### SUMMARY

The methods, devices, and systems described herein allow users to interact with augmented-reality content that is configured to be presented in one or more of a plurality of different presentation modes based on a user's physical surroundings and, specifically, how the user is reacting with their surroundings (e.g., real-world context), allowing for more efficient and effective interactions with the augmented-reality content while users are on the go, at a desk, and/or in other situations that can be benefitted by a context-adaptive AR UI.

As one example, content may be presented with a user-position based presentation mode when a user is seated and/or positioned adjacently to a desktop or table where they can interact with UI elements (e.g., a virtual keyboard, one or more virtual display elements) presented in proximity to a physical surface (e.g., a table).

The methods, devices, and systems described herein allow users to interact with AR content configured to be presented in a plurality of AR presentation modes based on sensor data from a user's AR headset indicating, for example, whether the user is moving or is dwelling in a particular location. For example, based on an indication that sensor data from the AR headset satisfies a movement dwell threshold time, one or more user-position based AR UIs may be presented (e.g., at a predefined set of locations based on a direction that the user is facing, or a physical object (e.g., a table) that is within the user's proximity).

A first example method is provided for determining whether to present a user-position based AR UI or a user-motion based AR UI. The first example method includes, in response to an indication to present user-interactable content via an augmented-reality (AR) headset, selecting an AR user interface (UI) of a plurality of AR UIs for presenting the user-interactable content. The first example method includes, in accordance with a determination, based on sensor data obtained by the AR headset, that the AR headset satisfies a movement dwell threshold time, presenting the user-interactable content in a user-position based AR UI of the plurality of AR UIs. The first example method includes, in accordance with another determination, based on other sensor data obtained by the AR headset, that the AR headset satisfies a movement threshold, presenting the user-interactable content in a user-motion based AR UI of a plurality of AR UIs.

A second example method is provided for presenting a UI-selection element to position UIs within position-based UI locations (e.g., while a movement dwell threshold time is satisfied). The second example method includes, while an AR UI that includes content is presented, by an AR headset, at respective position-based UI locations of a plurality of available position-based UI locations for the AR headset, presenting a UI-selection element in proximity to the plurality of available position-based UI locations and, while a gaze direct and/or head position of the user is directed toward the UI-selection element, obtaining a selection indication directed to the UI-selection element.

A third example method is provided for adaptively adjusting presentation of a notification indication based on detecting a user's focus on the respective representations of the notification. The third example method includes, while a gaze direction and/or a head position of a user is directed toward an AR UI comprising user-interactable content related to a particular application at a position-based UI location of a plurality of available position-based UI locations for an AR headset, in response to receiving a notification related to a different application than the particular application associated with the AR UI, presenting a representation of the notification in proximity to the AR UI. The third example method includes, based on a determination that the gaze direction and/or the head position has changed to be directed to the notification for a threshold dwell duration, causing a different representation of the notification to be presented, wherein the different representation includes one or more selectable options for interacting with the different application.

A fourth example method is provided for adaptively presenting a system tray user interface in proximity to user-interactable content in conjunction with determining that the user is looking away from a presentation location of the user-interactable content. The fourth example includes, while an AR UI that includes content is presented, by an AR device, at a respective position-based UI location of a plurality of available position-based UI locations for the AR device, determining, based on (i) a gaze direction and/or (ii) a head position detected by one or more sensors in electronic communication with the AR device, that the gaze direction and/or head position is directed away from any respective position-based UI location of the plurality of position-based UI locations, including the respective position-based UI location where the AR UI is presented. And the fourth example method includes, based on determining that a user is looking away from any of the respective position-based UI locations, causing display of a system tray user interface that is different than the AR UI.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A to 1E illustrate an example sequence of a user interacting with user-interactable content using a plurality of different AR UIs, in accordance with some embodiments.

FIGS. 2A to 2G illustrate an example sequence of a user interacting with a user interacting with an AR UI that is configured to progressively surface aspects of notifications based on detecting that a user is directing attention to a notification element presented adjacent to other user-interactable content, in accordance with some embodiments.

FIGS. 3A to 3D illustrate an example sequence of a user interacting with a plurality of different AR UIs presented in a set of position-based UI locations, in accordance with some embodiments.

FIGS. 4A to 4C illustrate an example sequence of a user interacting with a system-level UI element presented adjacent to a plurality of AR UIs presenting application-level interactable AR content, in accordance with some embodiments.

FIG. 5 illustrates a schematic diagram of an interactable AR system for presenting different modalities of AR content to a user of a head-wearable device, in accordance with some embodiments.

FIGS. 6A, 6B, 6C-1, 6C-2, 6D-1 and 6D-2 illustrate example MR and AR systems, in accordance with some embodiments.

FIG. 7 shows an example method flow chart for selecting one of a plurality of different sets of AR UIs for present user-interactable content to the user, in accordance with some embodiments.

FIG. 8 shows an example method flow chart for presenting a UI-selection element in conjunction with presenting user-interactable content within a set of AR UIs, in accordance with some embodiments.

FIG. 9 shows an example method flow chart for progressively surfacing aspects of notifications based on detecting that a user is directing attention to a notification element presented adjacent to other user-interactable content, in accordance with some embodiments.

FIG. 10 shows an example method flow chart for presenting a system-level UI element presented adjacent to a plurality of AR UIs presenting application-level interactable AR content, in accordance with some embodiments.

In accordance with customary practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with distinct types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and/or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are several types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IOT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

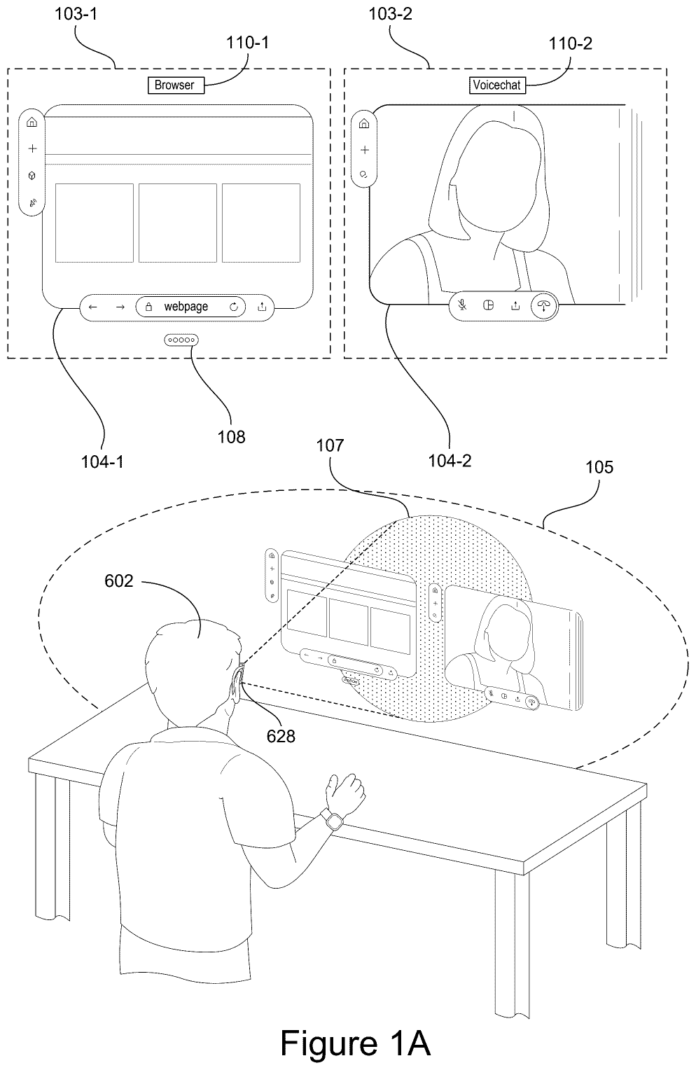

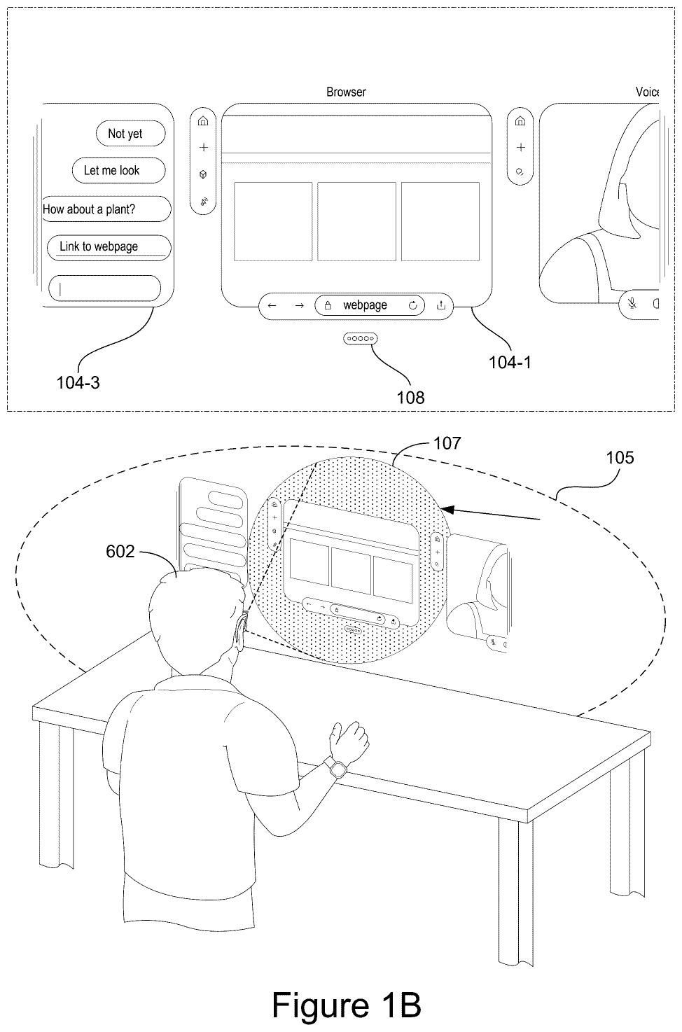

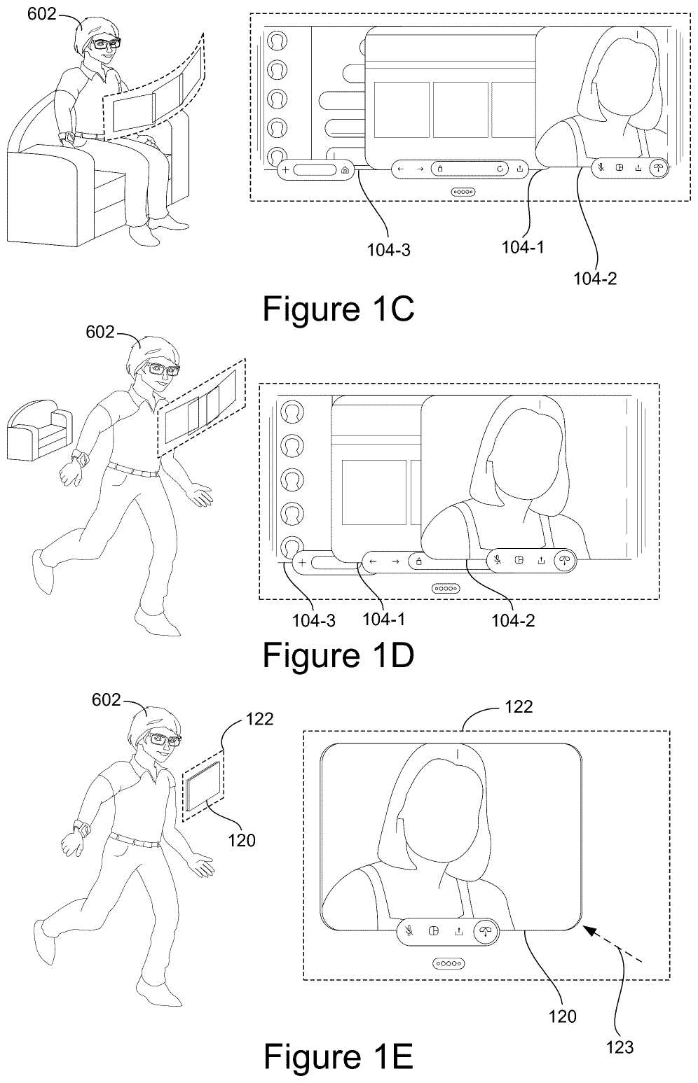

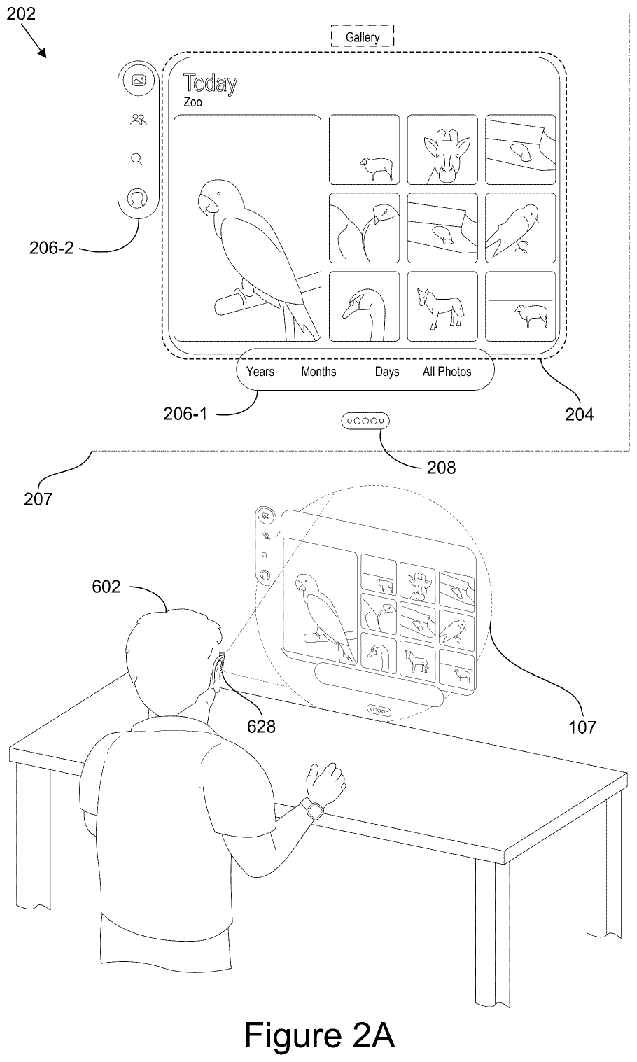

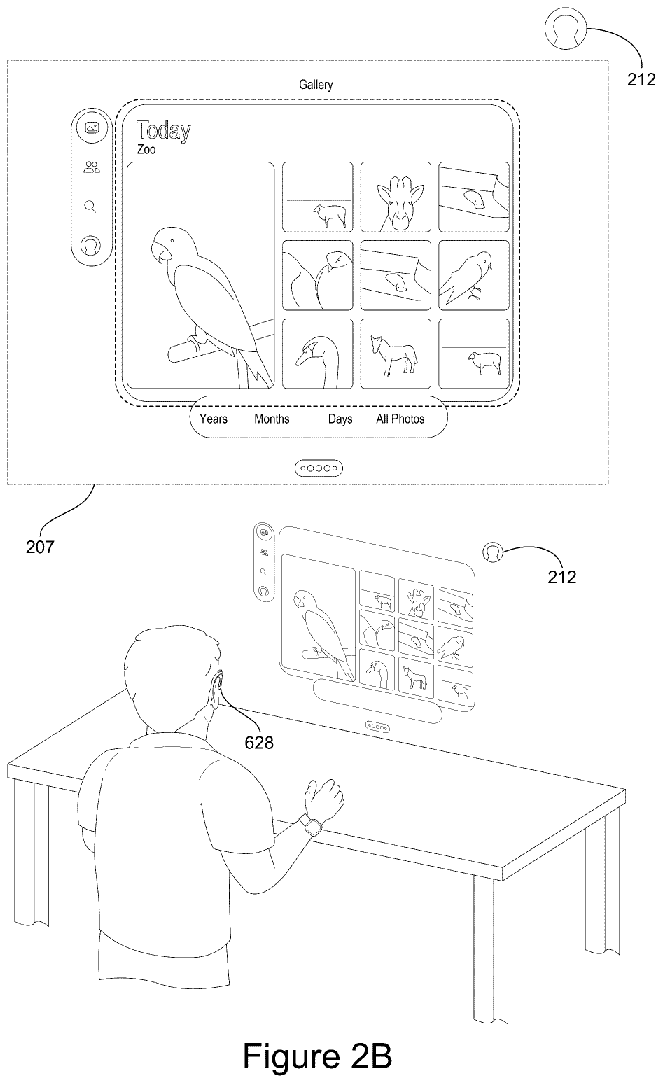

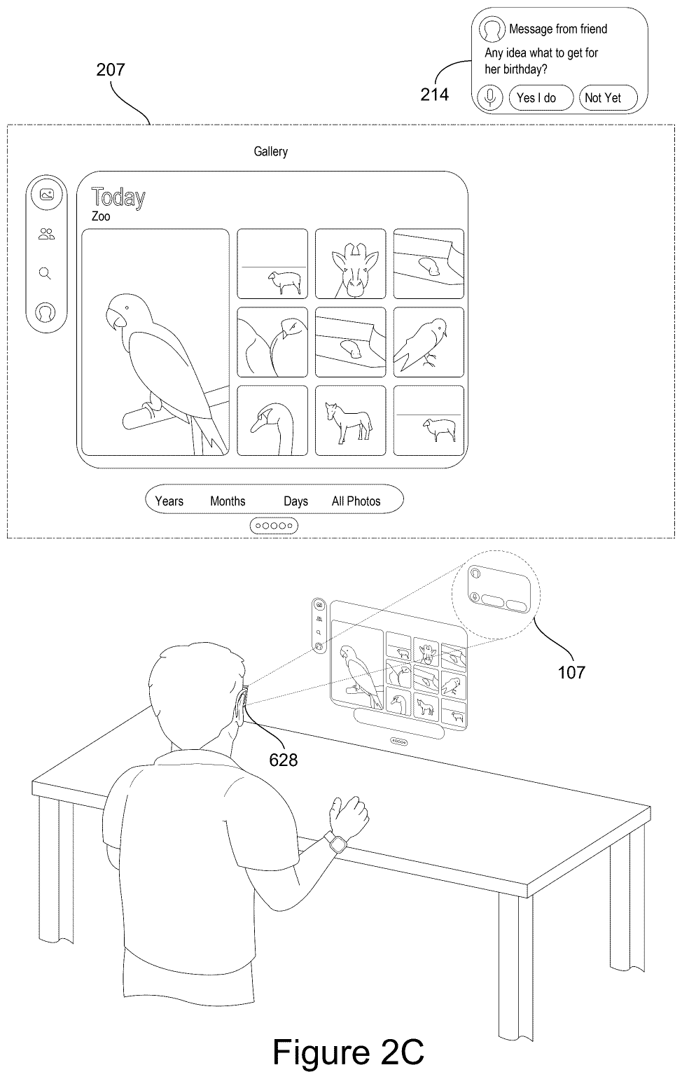

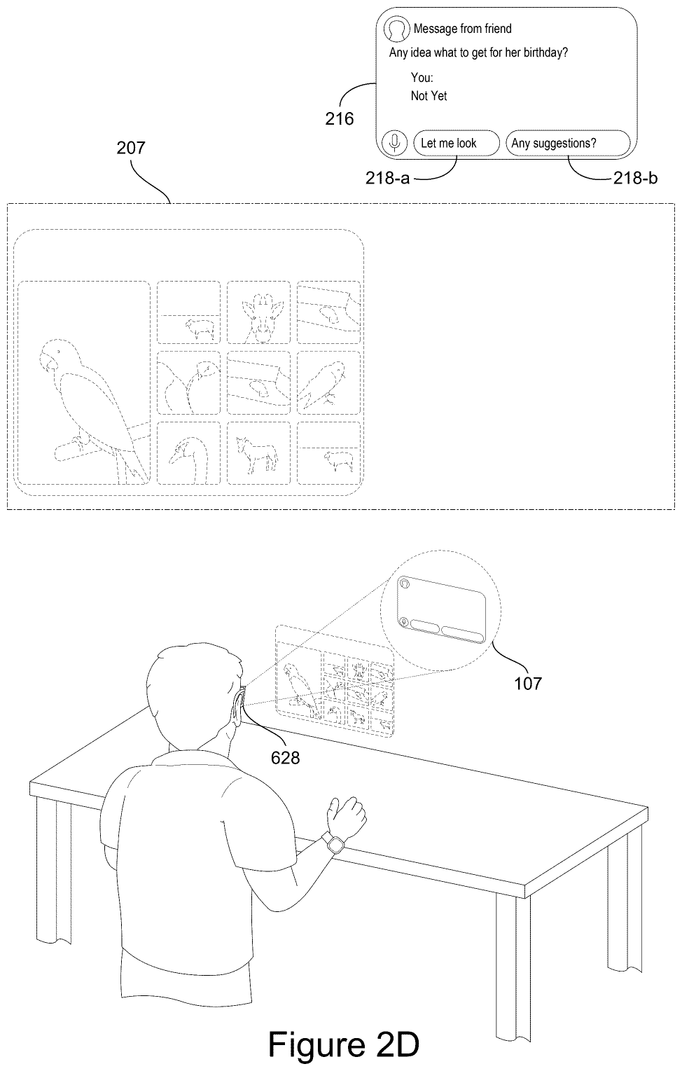

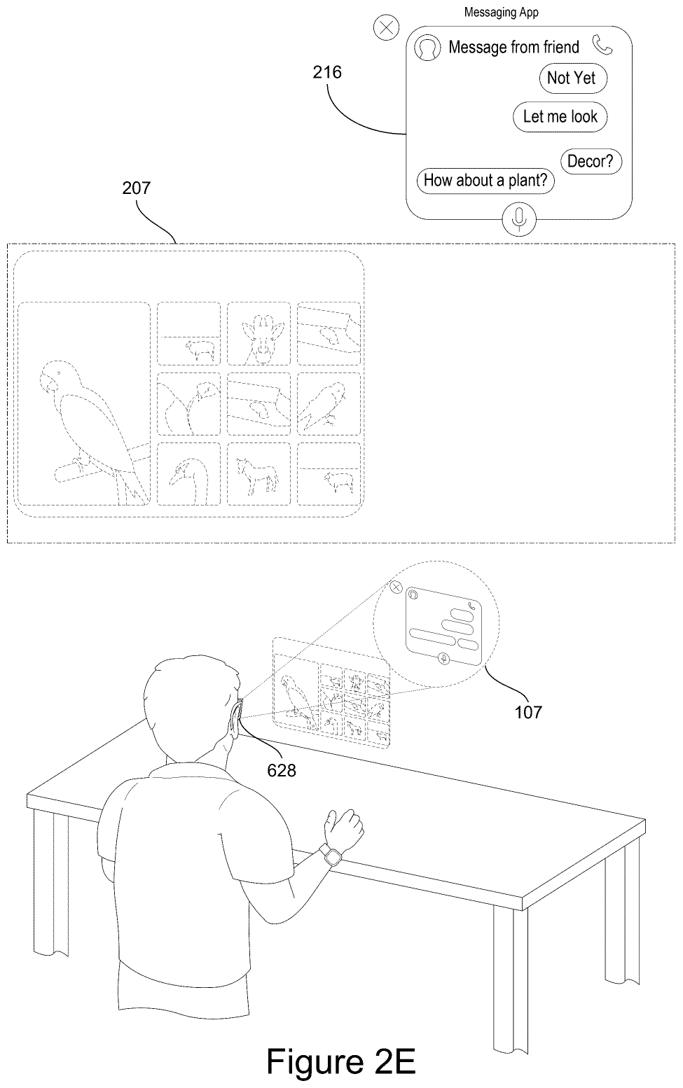

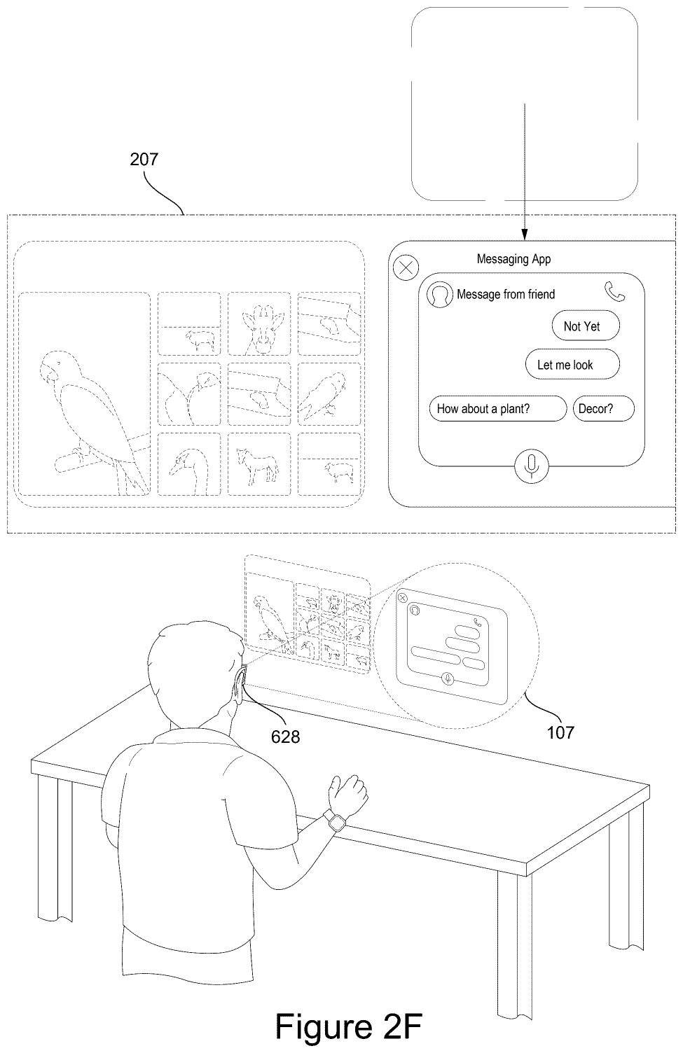

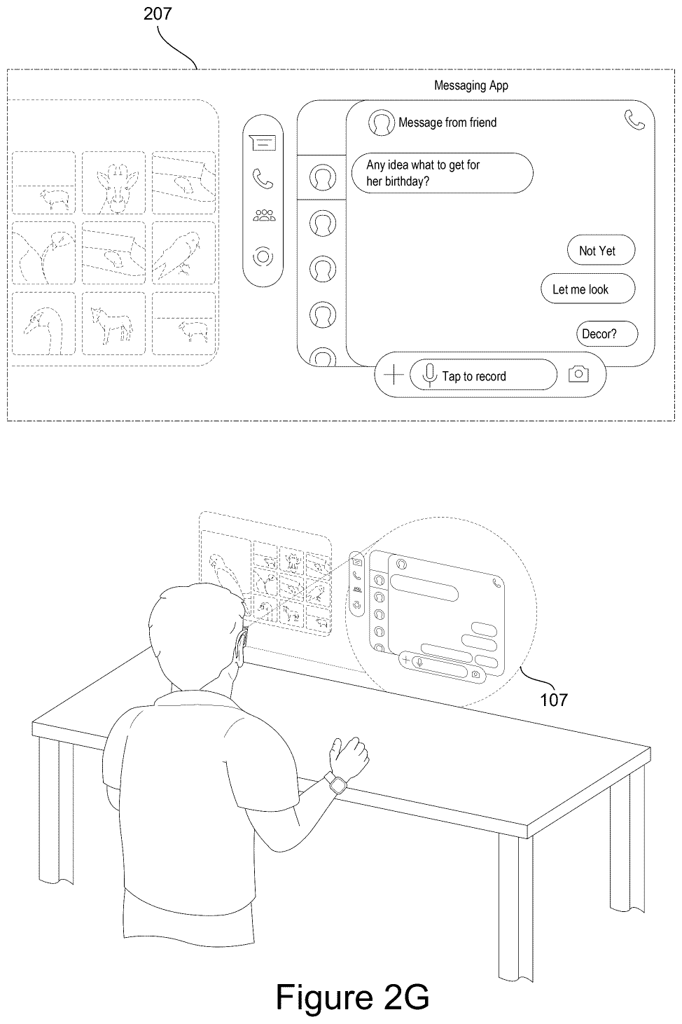

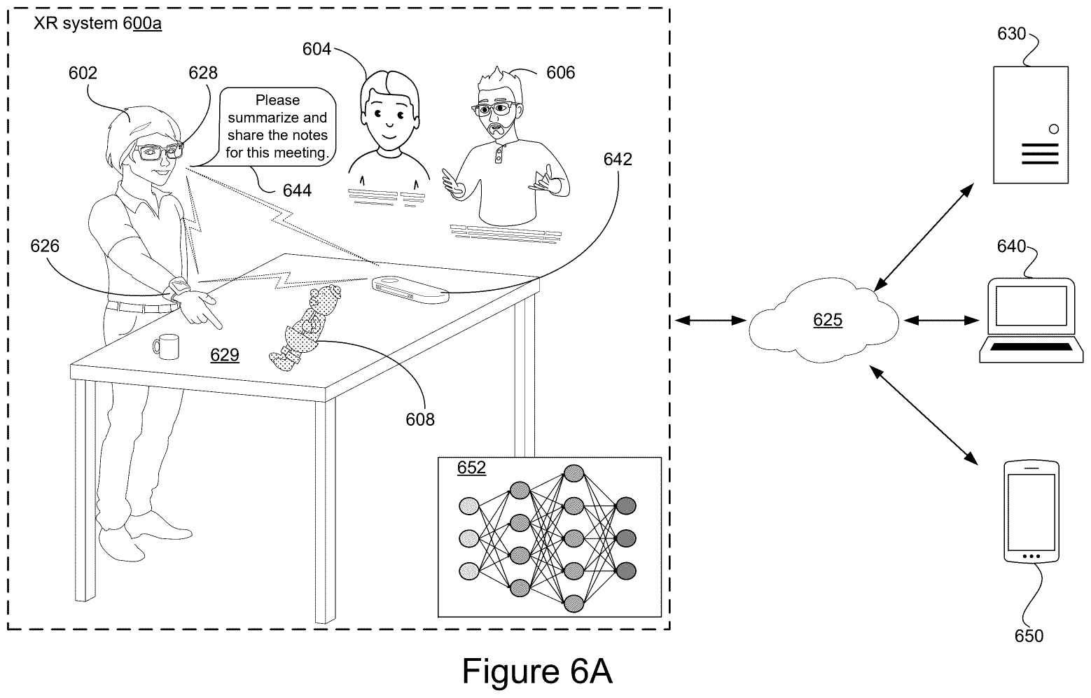

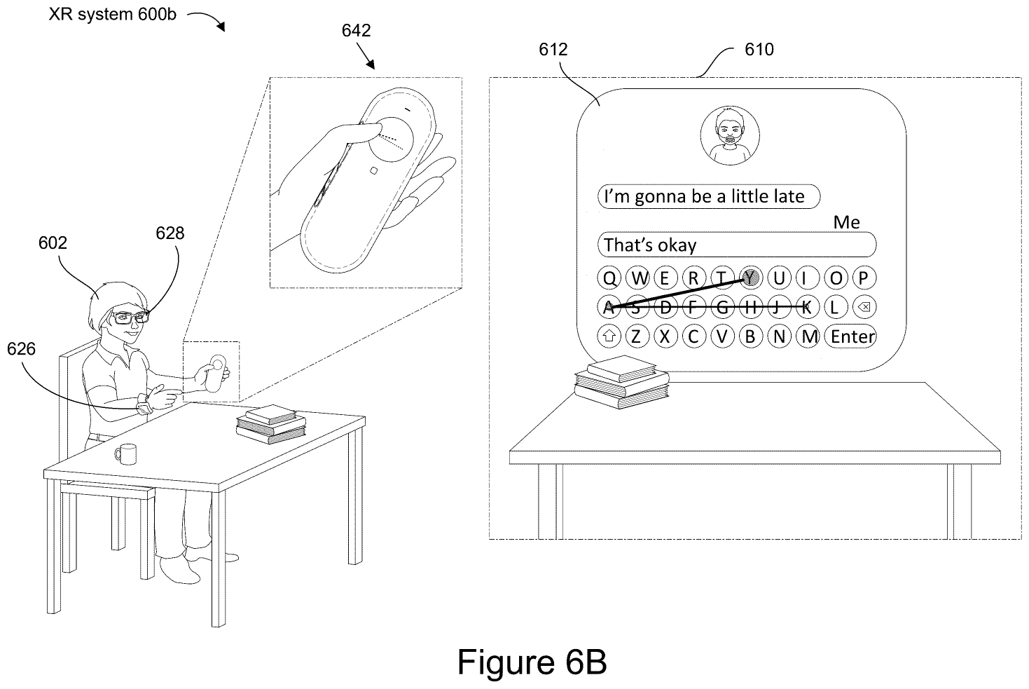

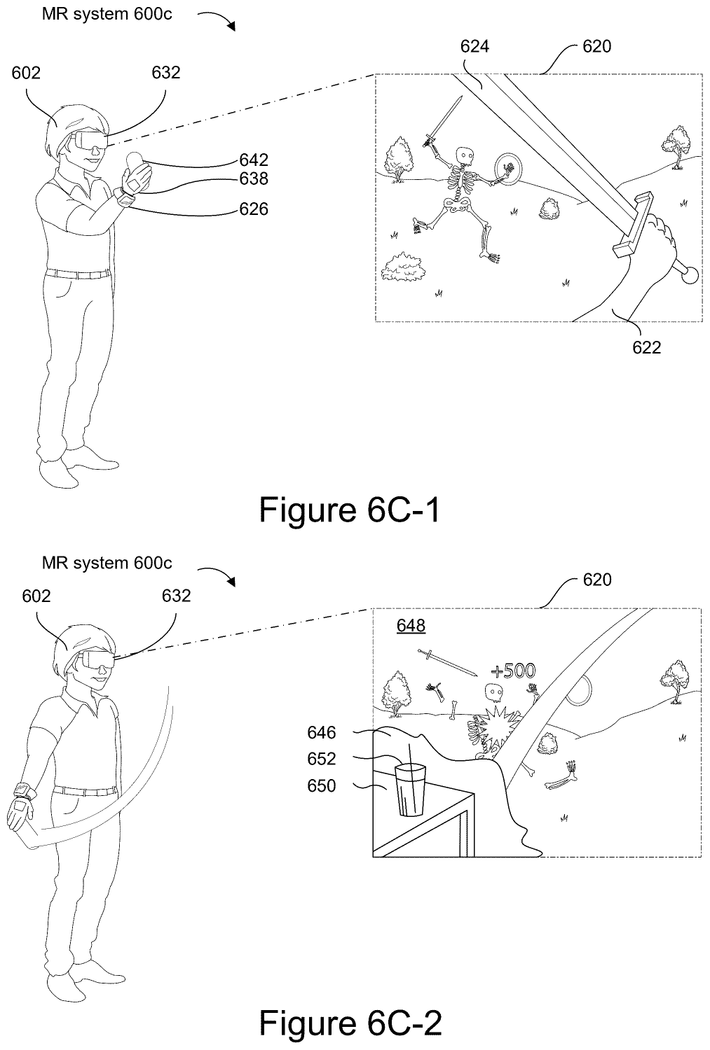

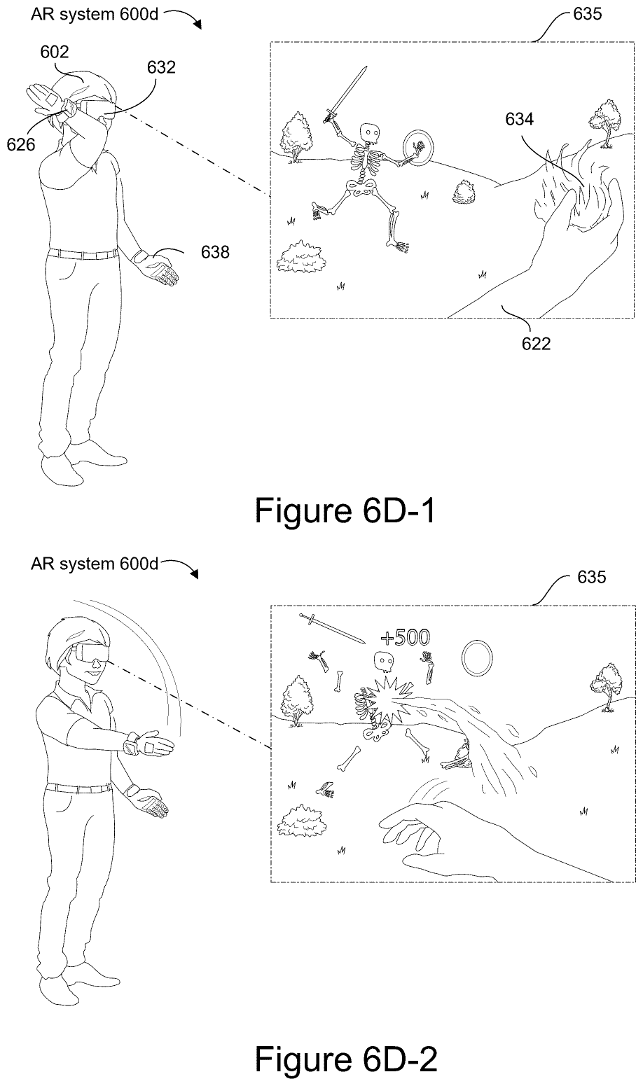

FIGS. 1A to 1E illustrate an example sequence of a user interacting with user-interactable content using a plurality of different AR UIs, in accordance with some embodiments. For ease of description, FIGS. 1A to 1E are described with respect to the systems and components thereof illustrated in FIGS. 6A to 6D-2. That is, FIGS. 1A to 1E show a user 602 using an AR device 628 to present interactable AR elements to the user 602.

Turning to FIG. 1A, the AR device 628 can be configured to present a plurality of different user interfaces associated with distinct AR content at a plurality of different position-based UI locations (e.g., an AR user interface 104-1, an AR user interface 104-2, etc.). Although FIG. 1A shows user-interactable content being presented in two different available position-based UI locations (e.g., a first position-based UI location 103-1, a second position-based UI location 103-2), other numbers of user-position based locations are contemplated as well (e.g., 5, 6, 7, or 8 locations).

In accordance with some embodiments, each of the position-based UI locations 103 is positioned in a particular point within the user's vicinity based on a UI-locating region 105 surrounding the user, which may be associated with a peripheral viewing region of respective cameras of the AR device 628. In some embodiments, the user 602 is able to re-position the position-based UI locations 103 to other positions within the UI-locating region 105, while the user-interactable content is being presented in the position-based UI presentation mode. In some embodiments, there is a designated field of view 107 associated the AR device 628. In some embodiments, the user-interactable content that is presented at any given moment is based on a direction of the field of view 107. In some embodiments, the UI-locating region 105 is determined based on a field of view of one or more sensors (e.g., imaging sensors) of the AR device 628, such that the UI-locating region 105 can be adjusted based on a current orientation of the AR device 628.

In accordance with some embodiments, the AR headset is causing the user-interactable content of the position-based AR UIs 104-1 and 104-2 to be presented at position-based UI locations based on the sensor data from the AR device 628 indicating that the AR headset satisfies a dwell threshold time (e.g., three seconds, five seconds, etc.). In some embodiments, one or more additional criteria may be used to indicate that the user-interactable content should be presented as user-position based AR UIs, as opposed to the user-motion based UIs presented in the later Figures in the sequence (e.g., the user-motion based AR UI 120 shown in FIG. 1E). In some embodiments, while the user-interactable content is presented as user-position based AR UIs, the position-based AR UIs are configured to be stationary with respect to the user (e.g., as the user rotates their head or makes other movements while remaining otherwise stationary).

FIG. 1B illustrates an example interaction in which the user-interactable AR content from FIG. 1A is being presented while the user 602 rotates their head with respect to the position-based AR UIs being presented, as represented by the change of direction of the field of view 107 associated with the AR device 628. As shown, when the user moves their head or otherwise causes an adjustment to the field of view 107 with respect to the position-based UI locations 103, a portion of a third position-based AR UI 104-3 is caused to be presented, and a portion of the second position-based AR UI 104-2 ceases to be presented, in accordance with some embodiments. That is, in some embodiments, when the user interactable content is being presented as user-position based AR UIs, the AR content that is presented from the respective AR UIs is based on the respective position-based UI locations that are determined to be within the user's field of view (e.g., based on the sensor data indicating a current angle of rotation of the user's head). In accordance with some embodiments, based on the adjusted direction of the field of view 107, the UI-locating region 105 is adjusted according to a new field of view of the respective sensors of the AR device 628.

FIGS. 1C to 1E illustrate the AR device 628 transitioning from presenting the plurality of position-based AR UIs as user-position based AR UIs to presenting the AR UIs as user-motion based AR UIs. In some embodiments, while presenting the user-interactable content in the user-position based AR UI mode, the AR headset can cause determination (e.g., based on sensor data obtained by the AR headset) that the AR headset satisfies a movement threshold (e.g., based on IMU data, position data, etc.). For example, the user 602 may be getting up and walking, and/or turning their head or shoulders away from the surface of a table or desk where they are sitting. In some embodiments, the sensor data includes data from one or more sensors separate from, but in electronic communication with the AR device 628, such as a smartphone, a wrist-wearable device (e.g., the wrist-wearable device 626), and/or a handheld intermediary device. Based on another determination, distinct from the determination discussed with respect to FIG. 1A, that the AR device 628 satisfies the movement threshold, the AR device 628 can be caused to transition from present the AR UIs in the user-position based AR UI mode to the user-motion based AR UI mode.

As shown by FIGS. 1C to 1E, as the user 602 transitions to movement, the presentation of the user-interactable content can gradually transition from the user-position based AR UI mode to the user-movement based AR UI mode. In some embodiments, the transition is based on the rate of change of the user's movement. For example, as the user gets up off of the couch, the user-position based AR UIs 104-1 to 104-3 collapse into one user-motion based AR UI 120. In some embodiments, while the user-interactable content is presented in the user-motion based UI mode, the AR headset is caused to obtain information indicating that the user 602 is moving and/or changing a field of view on which the user 602 is focusing. In accordance with obtaining the information indicating the moving and/or changing field of view, the AR device 628 can be caused to adjust the presentation of the user-motion based AR UI such that some correspondence is maintained between the user-motion based AR UI and a current field of view of the user.

In some embodiments, in accordance with the determining that the velocity surpasses the soft-leashing threshold velocity, the user-motion based AR UI 120 can be caused to have an adjusted correspondence that includes a delay between when (i) the moving and/or the changing field of view and (ii) the user-motion based AR UI returns to a user-motion based display location. In some embodiments, the user-motion based AR UI is adjustable within a user-motion based AR UI boundary area 122 (e.g., an AR UI boundary area). In some embodiments, the AR UI boundary area 122 is configured to remain centered within the field of view 107 associated with the AR device 628 and/or the UI-locating region 105. In some embodiments the user 602 can perform a gesture (e.g., an eye movement, and/or a hand gesture) to move the AR UI 120 within the AR UI boundary area 122, as indicated by the movement 123 from a default location to an upper left corner of the AR UI boundary area 122.

FIGS. 2A to 2G illustrate an example sequence of a user interacting with an AR UI that is configured to progressively surface aspects of notifications based on detecting that a user is directing attention to a notification element presented adjacent to other user-interactable content, in accordance with some embodiments.

FIG. 2A illustrates user-interactable content being presented within an AR content 202 by the AR device 628 (e.g., in the user-position based UI mode shown in FIG. 1A, and/or the user-movement based UI mode shown in FIG. 1E). For example, in accordance with some embodiments, the AR content 202 is being presented in the user-position based UI mode in FIG. 2A. While being presented in the user-position based AR UI mode, a plurality of user interface can be presented. A user interface 204 includes user-interactable content of a particular application that the user 602 is currently interacting with (e.g., an image-viewing application). The AR content 202 is being presented within a position-based UI location 207.

In accordance with some embodiments, one or more application-specific user interface elements (e.g., an application-specific user interface element 206-1 and an application-specific user interface element 206-2) are configured to be presented in the first presentation mode. One or more application-agnostic user interface elements can also be presented in the first presentation mode. For example, a position-based UI selection indicator 208 (e.g., a launcher UI) is presented adjacent to the user interface 204 that includes the presentation content that the user is currently interacting with. A user interface element 210 (e.g., a lookup UI) is presented in a different position that is also adjacent to the user interface 204, in accordance with some embodiments.

FIG. 2B shows another representation of the user-interactable content, after a notification is received from a different application than the application associated with the user-interactable content being presented at the position-based UI location. In accordance with receiving the notification of from the other application, a representation of the notification, notification indication 212 is presented in proximity to the position-based UI location 207.

FIG. 2C shows another representation of the user-interactable content after the user has directed attention to the notification indication 212 for a threshold dwell duration (which may be a default value, or an amount of time specifically configured by the user). In accordance with a determination that the user has directed their gaze toward the notification indication 212 for the threshold dwell duration as indicated by the adjusted field of view 107, a different representation of the notification, a notification information element 214, is caused to be presented at the location where the notification indication 212 had been presented. In accordance with some embodiments, the notification information element 214 includes other information about the notification that was received by the other AR application.

FIGS. 2D and 2E show further progressive adaptations to the representation of the notification based on the user 602 directing their gaze to the location where the respective representations of the notifications are being presented. In some embodiments, different user-interactable elements can be progressively presented as part of the gradual transition of the content being presented as part of the representation. For example, the user interface element 216 presented in FIG. 2D includes a plurality of different response elements 218-a and 218-b, which may be configured to be selected (e.g., by a gaze gesture, and/or hand gesture performed by the user). FIG. 2E shows a different representation, an AR UI preview element 220, which is a preview of an AR UI that would be presented within one a respective position-based UI location for the AR content associated with the notification.

FIG. 2F shows an AR UI being placed within a position-based UI location, in accordance with some embodiments. In some embodiments, the AR UI associated with the notification can be caused to be automatically placed within a position-based UI location automatically, without further user intervention, based on the user directing their gaze at respective representations of the AR content for a threshold AR UI instantiation time.

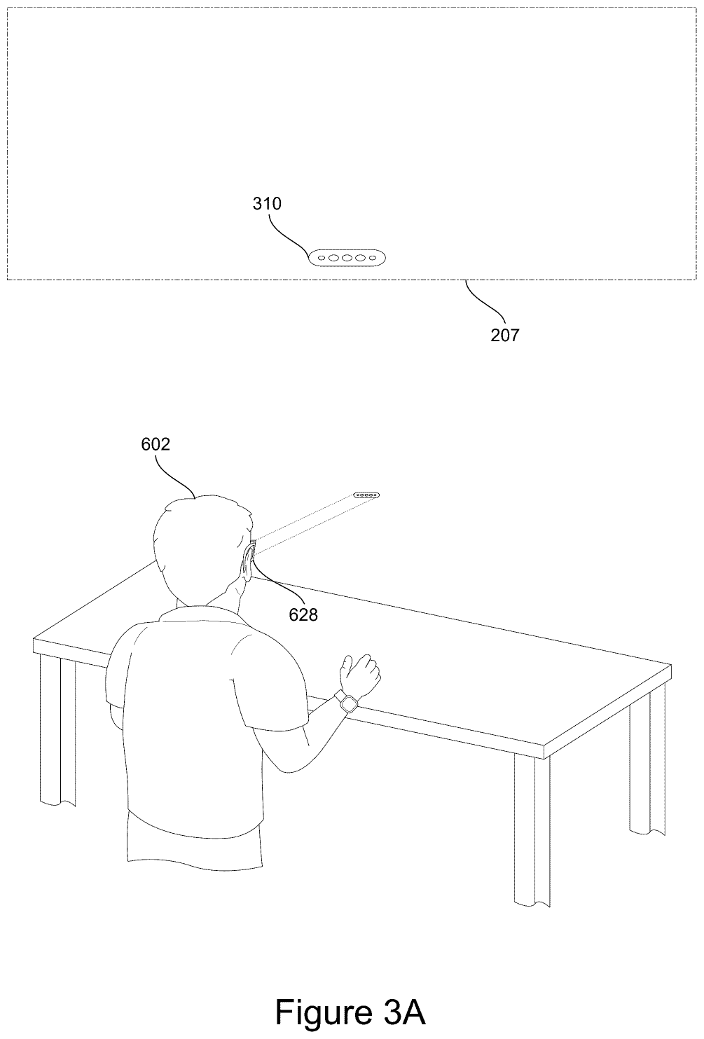

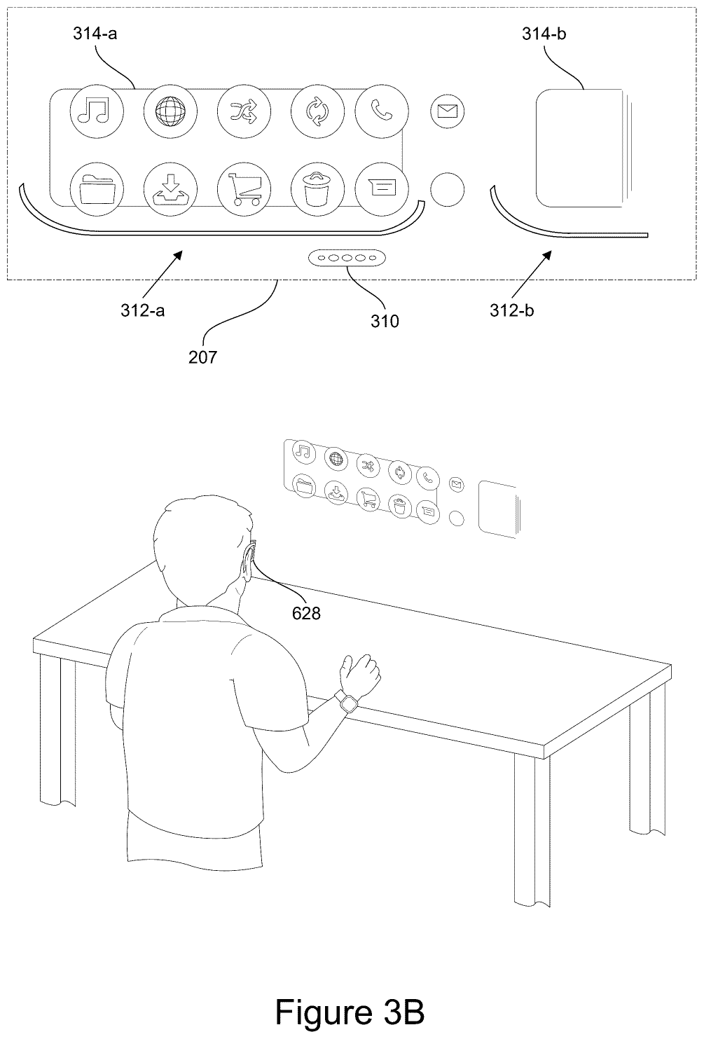

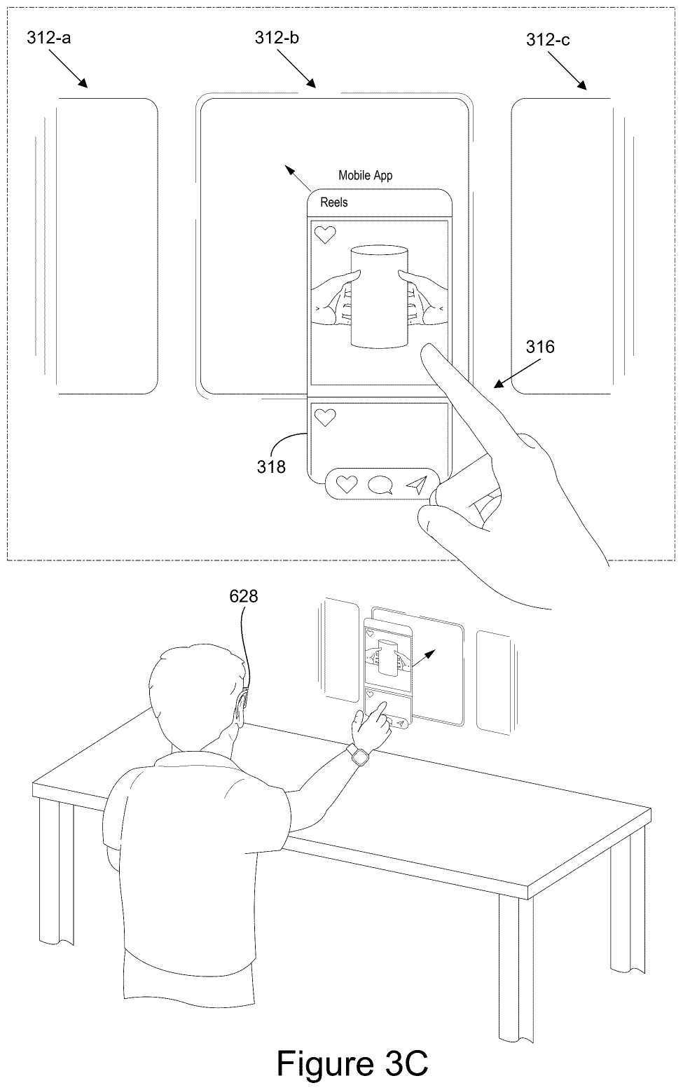

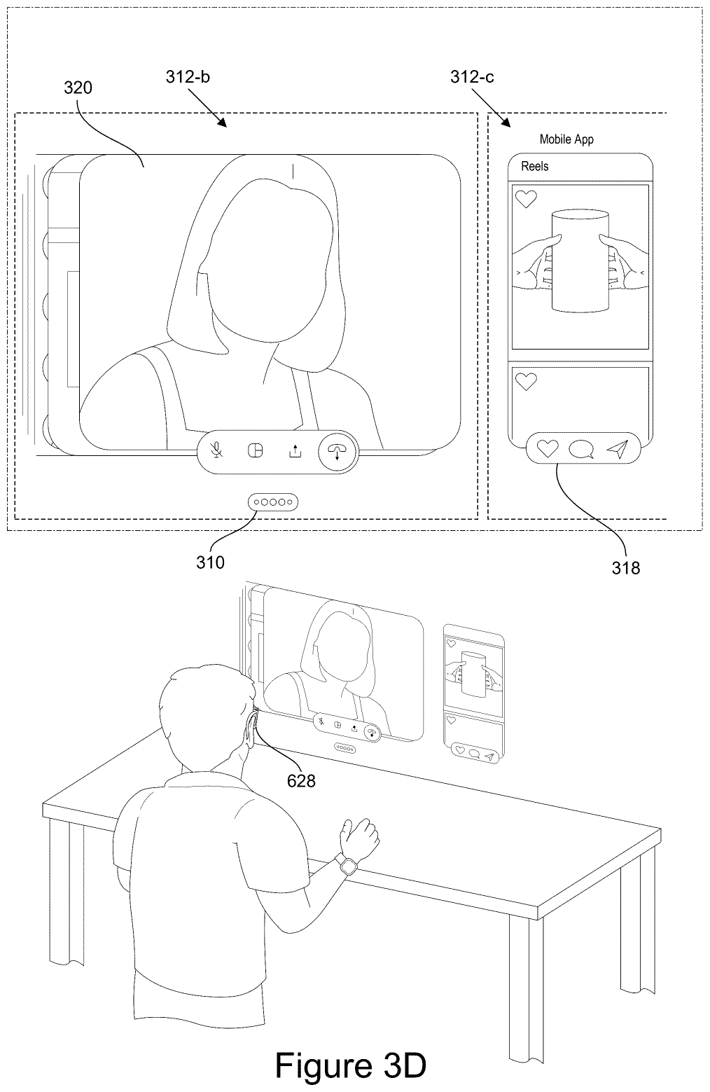

FIGS. 3A to 3D illustrate an example sequence of a user interacting with a plurality of different AR UIs presented in a set of position-based UI locations, in accordance with some embodiments.

FIG. 3A shows the user directing focus to a UI-selection element 310, which is being presented in proximity to one or more position-based UI locations corresponding to areas for presenting position-based AR UIs. The user 602 is directing focus towards the UI-selection element 310. In some embodiments, a visual appearance of the UI-selection element 310 is modified in accordance with a determination that the user has directed focus to the UI selection element for a threshold time.

FIG. 3B shows AR content being presented within each of the position-based UI locations 312-a and 312-b. In accordance with some embodiments, the AR UIs 314-a and 314-b presented within the position-based UI locations 312-a and 312-b include selectable options each associated with other AR UIs different than the AR UIs being presented. In some embodiments, the UI elements presented within the AR UIs 314-a and 314-b can be selected to cause the other content associated with the UI elements to be presented within one or more of the position-based UI locations 312.

FIG. 3C shows the user interacting with AR UIs that were caused to be launched by the UI elements presented with the AR UIs 314-a and 314-b. In accordance with some embodiments, the user is performing a gesture 316 directed the AR UI 318, which was previously being presented within the position-based UI location 312-a.

FIG. 3D shows the user completing the gesture 316 by placing the AR UI 318 within another position-based UI location 314-c. In accordance with some embodiments, when the AR UI 318 is placed within another position-based UI location 312-c, another AR UI 320 is caused to be presented within the position-base UI location 312-b. In other words, in accordance with some embodiments, the content that had previously been presented at the position-based UI location by the AR UI is replaced by the respective other content. In some embodiments, when a respective AR UI is placed within a position-based UI location (e.g., the position-based UI location 312-c) information about the respective AR content is stored and associated with the position-based UI location where the AR UI was placed. In other words, the stored information indicates that the content has been presented at that particular position-based UI location. In some embodiments, the stored information includes AR configuration information indicating configuration aspects for one or more user interface elements of the AR UI.

In accordance with some embodiments, when the AR UI 318 is removed from the position-based UI location 312-b, a stack of AR UIs (e.g., an augment-viewer user interface element) is caused to be presented at the position-based UI location 312-b. In some embodiments, in accordance with the user 602 selecting the AR of the augment-viewer user interface element, the AR device is caused to present an augment-switcher user interface that includes representations of the plurality of UIs in the stack of UIs at the position-based UI location. In accordance with some embodiments, the AR UIs in augment-switcher user interface is based on the stored information associated with the position-based UI location 312-b.

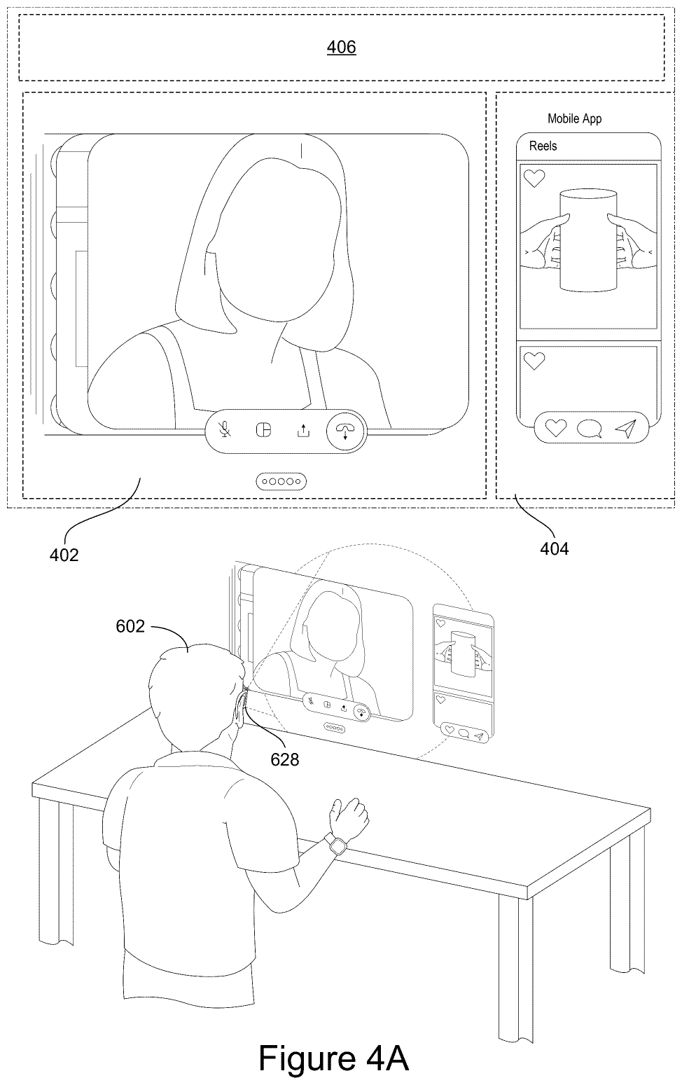

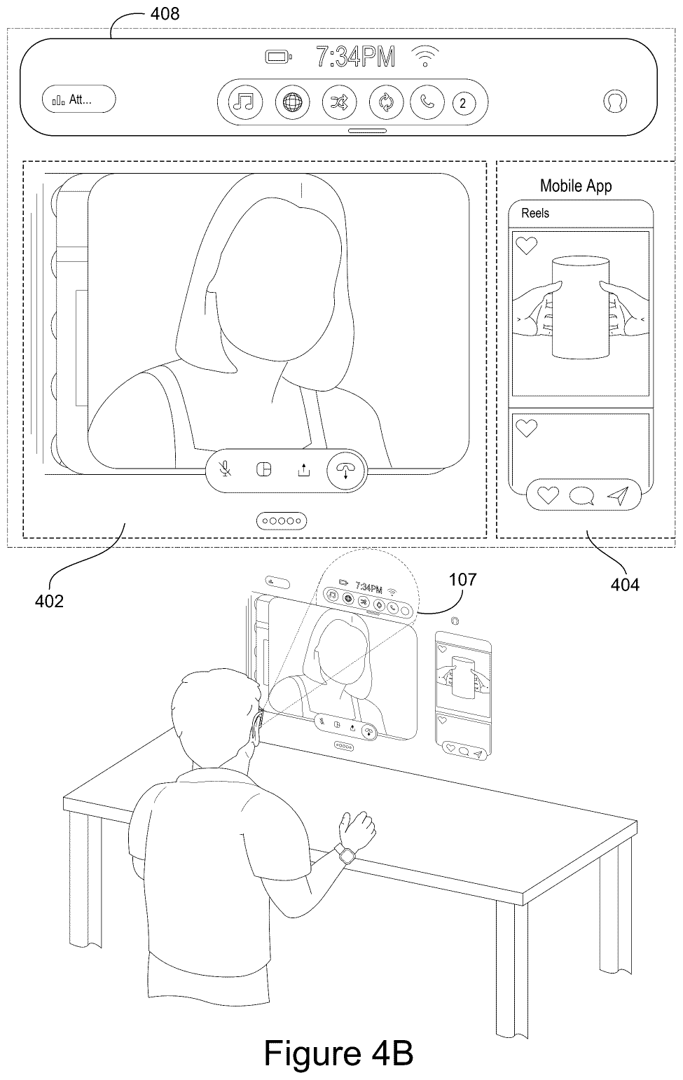

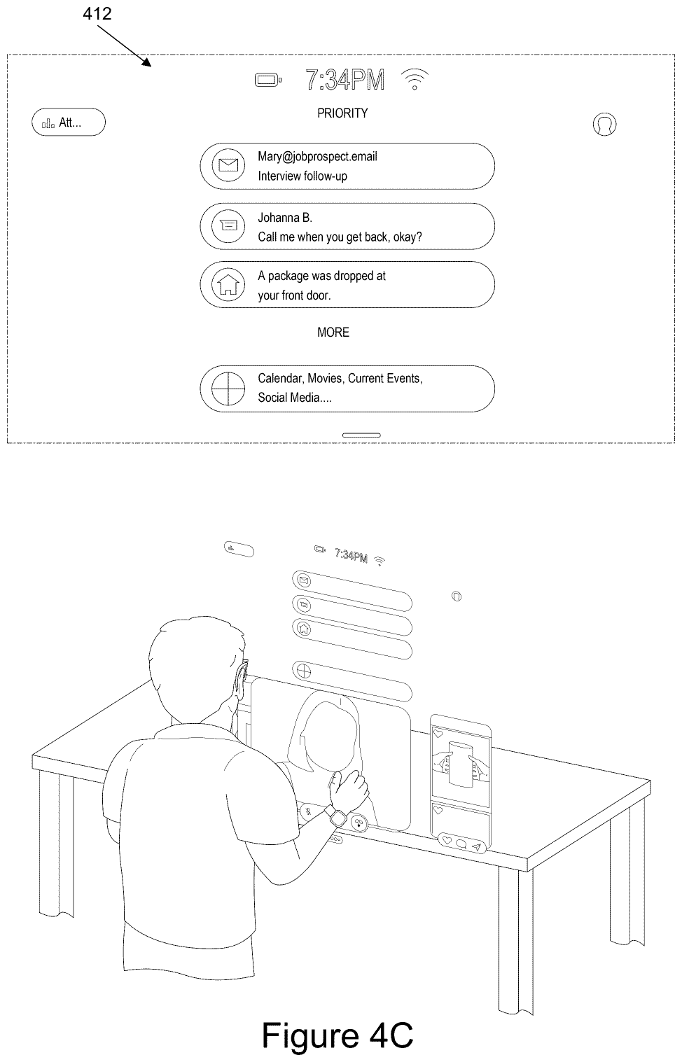

FIGS. 4A to 4C illustrate an example sequence of a user interacting with a system-level UI element presented adjacent to a plurality of AR UIs presenting application-level interactable AR content, in accordance with some embodiments.

FIG. 4A shows the user 602 interacting with a plurality of AR UIs using the AR device 628. The AR UIs are presented at respective position-based UI locations 402 and 404. In FIG. 4A the user 602 has just adjusted their gaze direction away from (e.g., above) the respective position-based UI locations 402 and 404. In accordance with some embodiments, the location where the user 602 has directed their gaze is known as a look-away UI location 406.

FIG. 4B shows another illustration of the AR content presented in FIG. 4A, where a system tray user interface 408 that is different than the user-interactable content presented within the AR UIs presented in the position-based UI locations 402 and 404. In some embodiments, the system tray user interface 408 is presented based on determining that one or more of (i) a gaze direction and (ii) a head position of the user is directed away from any of the AR UIs presented by the AR device 628. In some embodiments, the determination that the gaze direction or head position of the user is directed away from any of the AR UIs presented by the AR device 628 is determined based on data from one or more sensors of the AR device 628, or another electronic device in electronic communication with the AR device 628.

In accordance with some embodiments, the system tray user interface 408 includes one or more user interface elements for system-level operations, and one or more user interface elements for interacting with other AR content associated with different applications than the applications associated with the AR UIs presented in the position-based UI locations 402 and 404. In some embodiments, the system tray user interface 408 includes one or more first user interface elements for interacting with the content being presented at the AR UI at the particular position-based UI location. In some embodiments, the system tray user interface 408 includes one or more second user interface elements for interacting with a system component of the AR headset. In some embodiments, the system tray user interface includes one or more third user interface elements for interacting with different content associated with a different AR UI.

In some embodiments, while an AR UI includes content presented by an AR headset (e.g., the AR device 628) at a respective position-based UI location of a plurality of available position based UI locations for the AR headset, the AR headset can be caused to determine that the gaze direction and/or head position of the user 602 is directed away from any respective position-based UI location of the plurality of position-based UI location, include the respective position-based UI location where the AR UI is being presented. In some embodiment, one or more of (i) a gaze direction and/or a (ii) a head position detected by one or more sensors in electronic communication with the AR device are used to determine that the gaze direction and/or head position have moved away from the respective user position-based location.

FIG. 4C shows another representation 412 of the system tray user interface 408 that was presented in FIG. 4B. In accordance with some embodiments, the other representation 412 includes user interface elements that are not included in the system tray user interface 408 that is presented in FIG. 4B. For example, the representation 412 includes a scrollable list of notifications, which may be associated with one or more applications for presenting AR content, which may include AR content different than the user-interactable content being presented at the position-based UI locations 402 and 404 shown in FIGS. 4A and 4B.

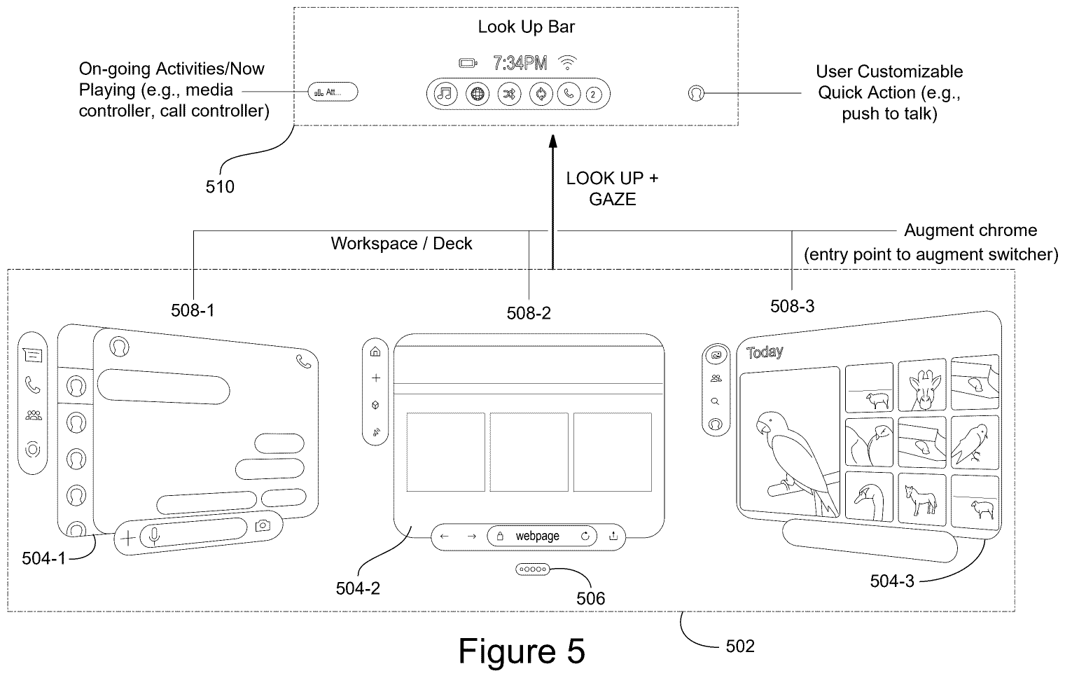

FIG. 5 illustrates a schematic diagram of an interactable AR system for presenting different modalities of AR content to a user of a head-wearable device, in accordance with some embodiments. A block 502 includes the user interfaces 104-1, 104-2, and 104-3, which may be presented while the AR content is being presented by the AR device 628 in a user-position based presentation mode (e.g., the user-position based presentation mode shown in FIG. 1A). As shown in FIG. 5, in some embodiments, respective user interfaces shown in the block 502 can be presented in a preferred presentation mode, regardless of whether the first presentation criteria are satisfied. For example, the user interface 104-3 is shown being presented in the transient presentation mode even though the first presentation criteria are satisfied for presenting the content in the user-position based presentation mode.

### Example Extended-Reality Systems

FIGS. 6A, 6B, 6C-1, 6C-2, 6D-1 and 6D-2 illustrate example XR systems that include AR and MR systems, in accordance with some embodiments. FIG. 6A shows a first AR system 600a and first example user interactions using a wrist-wearable device 626, a head-wearable device (e.g., AR device 628), and/or a HIPD 642. FIG. 6B shows a second AR system 600b and second example user interactions using a wrist-wearable device 626, AR device 628, and/or an HIPD 642. FIGS. 6C-1 and 6C-2 show a third MR system 600c and third example user interactions using a wrist-wearable device 626, a head-wearable device (e.g., an MR device such as a VR device), a smart textile-based garment 638 (e.g., wearable haptic gloves), and/or an HIPD 642. FIGS. 6D-1 and 6D-2 show a fourth AR system 600d and fourth example user interactions using a wrist-wearable device 626, a head-wearable device 626, AR device 628, and/or a smart textile-based garment 638. As the skilled artisan will appreciate upon reading the descriptions provided herein, the above-example AR and MR systems (described in detail below) can perform various functions and/or operations.

The wrist-wearable device 626, the head-wearable devices, and/or the HIPD 642 can communicatively couple via a network 625 (e.g., cellular, near field, Wi-Fi, personal area network, wireless LAN). Additionally, the wrist-wearable device 626, the head-wearable device, and/or the HIPD 642 can also communicatively couple with one or more servers 630, computers 640 (e.g., laptops, computers), mobile devices 650 (e.g., smartphones, tablets), and/or other electronic devices via the network 625 (e.g., cellular, near field, Wi-Fi, personal area network, wireless LAN). Similarly, a smart textile-based garment, when used, can also communicatively couple with the wrist-wearable device 626, the head-wearable device(s), the HIPD 642, the one or more servers 630, the computers 640, the mobile devices 650, and/or other electronic devices via the network 625 to provide inputs.

Turning to FIG. 6A, a user 602 is shown wearing the wrist-wearable device 626 and the AR device 628 and having the HIPD 642 on their desk. The wrist-wearable device 626, the AR device 628, and the HIPD 642 facilitate user interaction with an AR environment. In particular, as shown by the first AR system 600a, the wrist-wearable device 626, the AR device 628, and/or the HIPD 642 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 626, the AR device, and/or the HIPD 642. In addition, the user 602 is also able to directly view physical objects in the environment, such as a table 629, through transparent lens(es) and waveguide(s) of the AR device 628. Alternatively, an MR device could be used in place of the AR device 628 and a similar user experience can take place, but the user would not be directly viewing physical objects in the environment, such as table 629, and would instead be presented with a virtual reconstruction of the table 629 produced from one or more sensors of the MR device (e.g., an outward facing camera capable of recording the surrounding environment).

The user 602 can use any of the wrist-wearable device 626, the AR device 628 (e.g., through physical inputs at the AR device and/or built-in motion tracking of a user's extremities), a smart-textile garment, externally mounted extremity tracking device, the HIPD 642 to provide user inputs, etc. For example, the user 602 can perform one or more hand gestures that are detected by the wrist-wearable device 626 (e.g., using one or more EMG sensors and/or IMUs built into the wrist-wearable device) and/or AR device 628 (e.g., using one or more image sensors or cameras) to provide a user input. Alternatively, or additionally, the user 602 can provide a user input via one or more touch surfaces of the wrist-wearable device 626, the AR device 628, and/or the HIPD 642, and/or voice commands captured by a microphone of the wrist-wearable device 626, the AR device 628, and/or the HIPD 642. The wrist-wearable device 626, the AR device 628, and/or the HIPD 642 include an artificially intelligent digital assistant to help the user in providing a user input (e.g., completing a sequence of operations, suggesting different operations or commands, providing reminders, confirming a command). For example, the digital assistant can be invoked through an input occurring at the AR device 628 (e.g., via an input at a temple arm of the AR device 628). In some embodiments, the user 602 can provide a user input via one or more facial gestures and/or facial expressions. For example, cameras of the wrist-wearable device 626, the AR device 628, and/or the HIPD 642 can track the eyes of the user 602 for navigating a user interface.

The wrist-wearable device 626, the AR device 628, and/or the HIPD 642 can operate alone or in conjunction to allow the user 602 to interact with the AR environment. In some embodiments, the HIPD 642 is configured to operate as a central hub or control center for the wrist-wearable device 626, the AR device 628, and/or another communicatively coupled device. For example, the user 602 can provide an input to interact with the AR environment at any of the wrist-wearable device 626, the AR device 628, and/or the HIPD 642, and the HIPD 642 can identify one or more back-end and front-end tasks to cause the performance of the requested interaction and distribute instructions to cause the performance of the one or more back-end and front-end tasks at the wrist-wearable device 626, the AR device 628, and/or the HIPD 642. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 642 can perform the back-end tasks and provide the wrist-wearable device 626 and/or the AR device 628 operational data corresponding to the performed back-end tasks such that the wrist-wearable device 626 and/or the AR device 628 can perform the front-end tasks. In this way, the HIPD 642, which has more computational resources and greater thermal headroom than the wrist-wearable device 626 and/or the AR device 628, performs computationally intensive tasks and reduces the computer resource utilization and/or power usage of the wrist-wearable device 626 and/or the AR device 628.

In the example shown by the first AR system 600a, the HIPD 642 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 642 performs back-end tasks for processing and/or rendering image data (and other data) associated with the AR video call and provides operational data associated with the performed back-end tasks to the AR device 628 such that the AR device 628 performs front-end tasks for presenting the AR video call (e.g., presenting the avatar 604 and the digital representation of the contact 606).

In some embodiments, the HIPD 642 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 642. In particular, the HIPD 642 and the AR device 628 operate in conjunction to determine a location for presenting the avatar 604 and the digital representation of the contact 606. In some embodiments, information can be presented within a predetermined distance from the HIPD 642 (e.g., within five meters). For example, as shown in the first AR system 600a, virtual object 608 is presented on the desk some distance from the HIPD 642. Similar to the above example, the HIPD 642 and the AR device 628 can operate in conjunction to determine a location for presenting the virtual object 608. Alternatively, in some embodiments, presentation of information is not bound by the HIPD 642. More specifically, the avatar 604, the digital representation of the contact 606, and the virtual object 608 do not have to be presented within a predetermined distance of the HIPD 642. While an AR device 628 is described working with an HIPD, an MR headset can be interacted with in the same way as the AR device 628.

User inputs provided at the wrist-wearable device 626, the AR device 628, and/or the HIPD 642 are coordinated such that the user can use any device to initiate, continue, and/or complete an operation. For example, the user 602 can provide a user input to the AR device 628 to cause the AR device 628 to present the virtual object 608 and, while the virtual object 608 is presented by the AR device 628, the user 602 can provide one or more hand gestures via the wrist-wearable device 626 to interact and/or manipulate the virtual object 608. While an AR device 628 is described working with a wrist-wearable device 626, an MR headset can be interacted with in the same way as the AR device 628.

### Integration of Artificial Intelligence With XR Systems

FIG. 6A illustrates an interaction in which an artificially intelligent virtual assistant can assist in requests made by a user 602. The AI virtual assistant can be used to complete open-ended requests made through natural language inputs by a user 602. For example, in FIG. 6A the user 602 makes an audible request 644 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 6A also illustrates an example neural network 652 used in Artificial Intelligence applications. Uses of Artificial Intelligence (AI) are varied and encompass many distinct aspects of the devices and systems described herein. AI capabilities cover a diverse range of applications and deepen interactions between the user 602 and user devices (e.g., the AR device 628, an MR device 632, the HIPD 642, the wrist-wearable device 626). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein, that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 602 can interact with an AI model through natural language inputs captured by a voice sensor, text inputs, or any other input modality that accepts natural language and/or a corresponding voice sensor module. In another instance, input is provided by tracking the eye gaze of a user 602 via a gaze tracker module. Additionally, the AI model can also receive inputs beyond those supplied by a user 602. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 628) or from multiple devices that are in communication with each other (e.g., a system that includes at least two of an AR device 628, an MR device 632, the HIPD 642, the wrist-wearable device 626, etc.). The AI model can also access additional information (e.g., one or more servers 630, the computers 640, the mobile devices 650, and/or other electronic devices) via a network 625.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 628, an MR device 632, the HIPD 642, the wrist-wearable device 626) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 628, an MR device 632, the HIPD 642, the wrist-wearable device 626), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 642), haptic feedback can provide information to the user 602. An AI model can also use the inputs described above to determine the appropriate modality and device(s) to present content to the user (e.g., a user walking on a busy road can be presented with an audio output instead of a visual output to avoid distracting the user 602).

### Example Augmented Reality Interaction

FIG. 6B shows the user 602 wearing the wrist-wearable device 626 and the AR device 628 and holding the HIPD 642. In the second AR system 600b, the wrist-wearable device 626, the AR device 628, and/or the HIPD 642 are used to receive and/or provide one or more messages to a contact of the user 602. In particular, the wrist-wearable device 626, the AR device 628, and/or the HIPD 642 detect and coordinate one or more user inputs to initiate a messaging application and prepare a response to a received message via the messaging application.

In some embodiments, the user 602 initiates, via a user input, an application on the wrist-wearable device 626, the AR device 628, and/or the HIPD 642 that causes the application to initiate on at least one device. For example, in the second AR system 600b the user 602 performs a hand gesture associated with a command for initiating a messaging application (represented by messaging user interface 612); the wrist-wearable device 626 detects the hand gesture; and, based on a determination that the user 602 is wearing the AR device 628, causes the AR device 628 to present a messaging user interface 612 of the messaging application. The AR device 628 can present the messaging user interface 612 to the user 602 via its display (e.g., as shown by a field of view 610 of the user 602). In some embodiments, the application is initiated and can be run on the device (e.g., the wrist-wearable device 626, the AR device 628, and/or the HIPD 642) that detects the user input to initiate the application, and the device provides another device operational data to cause the presentation of the messaging application. For example, the wrist-wearable device 626 can detect the user input to initiate a messaging application, initiate and run the messaging application, and provide operational data to the AR device 628 and/or the HIPD 642 to cause presentation of the messaging application. Alternatively, the application can be initiated and run at a device other than the device that detected the user input. For example, the wrist-wearable device 626 can detect the hand gesture associated with initiating the messaging application and cause the HIPD 642 to run the messaging application and coordinate the presentation of the messaging application.

Further, the user 602 can provide a user input provided at the wrist-wearable device 626, the AR device 628, and/or the HIPD 642 to continue and/or complete an operation initiated at another device. For example, after initiating the messaging application via the wrist-wearable device 626 and while the AR device 628 presents the messaging user interface 612, the user 602 can provide an input at the HIPD 642 to prepare a response (e.g., shown by the swipe gesture performed on the HIPD 642). The gestures of the user 602 directed to the HIPD 642 can be provided and/or displayed on another device. For example, the swipe gestures of the user 602 performed on the HIPD 642 are displayed on a virtual keyboard of the messaging user interface 612 displayed by the AR device 628.

In some embodiments, the wrist-wearable device 626, the AR device 628, the HIPD 642, and/or other communicatively coupled devices can present one or more notifications to the user 602. The notification can be an indication of a new message, an incoming call, an application update, a status update, etc. The user 602 can select the notification via the wrist-wearable device 626, the AR device 628, or the HIPD 642 and cause presentation of an application or operation associated with the notification on at least one device. For example, the user 602 can receive a notification that a message was received at the wrist-wearable device 626, the AR device 628, the HIPD 642, and/or other communicatively coupled device and provide a user input at the wrist-wearable device 626, the AR device 628, and/or the HIPD 642 to review the notification, and the device detecting the user input can cause an application associated with the notification to be initiated and/or presented at the wrist-wearable device 626, the AR device 628, and/or the HIPD 642.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 628 can present to the user 602 game application data and the HIPD 642 can use a controller to provide inputs to the game. Similarly, the user 602 can use the wrist-wearable device 626 to initiate a camera of the AR device 628, and the user can use the wrist-wearable device 626, the AR device 628, and/or the HIPD 642 to manipulate the image capture (e.g., zoom in or out, apply filters) and capture image data.

While an AR device 628 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances, an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a comparable manner to an MR headset, which is described below in the proceeding sections.

### Example Mixed Reality Interaction

Turning to FIGS. 6C-1 and 6C-2, the user 602 is shown wearing the wrist-wearable device 626 and an MR device 632 (e.g., a device capable of providing either an entirely VR experience or an MR experience that displays object(s) from a physical environment at a display of the device) and holding the HIPD 642. In the third MR system 600c, the wrist-wearable device 626, the MR device 632, and/or the HIPD 642 are used to interact within an MR environment, such as a VR game or other MR/VR application. While the MR device 632 presents a representation of a VR game (e.g., first MR game environment 620) to the user 602, the wrist-wearable device 626, the MR device 632, and/or the HIPD 642 detect and coordinate one or more user inputs to allow the user 602 to interact with the VR game.

In some embodiments, the user 602 can provide a user input via the wrist-wearable device 626, the MR device 632, and/or the HIPD 642 that causes an action in a corresponding MR environment. For example, the user 602 in the third MR system 600c (shown in FIG. 6C-1) raises the HIPD 642 to prepare for a swing in the first MR game environment 620. The MR device 632, responsive to the user 602 raising the HIPD 642, causes the MR representation of the user 622 to perform a similar action (e.g., raise a virtual object, such as a virtual sword 624). In some embodiments, each device uses respective sensor data and/or image data to detect the user input and provide an accurate representation of the motion of the user 602. For example, image sensors (e.g., SLAM cameras or other cameras) of the HIPD 642 can be used to detect a position of the HIPD 642 relative to the body of the user 602 such that the virtual object can be positioned appropriately within the first MR game environment 620; sensor data from the wrist-wearable device 626 can be used to detect a velocity at which the user 602 raises the HIPD 642 such that the MR representation of the user 622 and the virtual sword 624 are synchronized with the movements of the user 602; and image sensors of the MR device 632 can be used to represent the body of the user 602, boundary conditions, or real-world objects within the first MR game environment 620. In some embodiments, the same effects can be obtained, where the user 602 provides a user input via the wrist wearable device 626, the MR device 632, and/or the smart textile-based garments 638 that causes an action in a corresponding MR environment. For example, the user 602 in the fourth AR system 600d (shown in a second MR game environment 635 in FIG. 6D-1) performs a similar motion to the one outlined above, and this causes the MR representation of the user 622 in the second MR game environment 635 to perform a synchronized but distinct representation of the motion of the user (for example, the MR representation of the user throwing virtual flames 634 when the user lowers their hand that is wearing the wrist wearable device 626 and/or the smart textile-based garments 638).

In FIG. 6C-2, the user 602 performs a downward swing while holding the HIPD 642. The downward swing is detected by the wrist-wearable device 626, the MR device 632, and/or the HIPD 642 and a corresponding action is performed in the first MR game environment 620. In some embodiments, the data captured by each device is used to improve the user's experience within the MR environment. For example, sensor data of the wrist-wearable device 626 can be used to determine a speed and/or force at which the downward swing is performed and image sensors of the HIPD 642 and/or the MR device 632 can be used to determine a location of the swing and how it should be represented in the first MR game environment 620, which, in turn, can be used as inputs for the MR environment (e.g., game mechanics, which can use detected speed, force, locations, and/or aspects of actions of the user 602 to classify a user's inputs (e.g., user performs a light strike, hard strike, critical strike, glancing strike, miss) or calculate an output (e.g., amount of damage)).

FIG. 6C-2 further illustrates that a portion of the physical environment is reconstructed and displayed at a display of the MR device 632 while the first MR game environment 620 is being displayed. In this instance, a reconstruction of the physical environment 646 is displayed in place of a portion of the first MR game environment 620 when object(s) in the physical environment are potentially in the path of the user (e.g., a collision with the user and an object in the physical environment are likely). Thus, this first MR game environment 620 includes (i) an immersive VR portion 648 (e.g., an environment that does not have a corollary counterpart in a nearby physical environment) and (ii) a reconstruction of the physical environment 646 (e.g., table 629 and the cup on the table). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 626, the MR device 632, and/or the HIPD 642 are described as detecting user inputs, in some embodiments, user inputs are detected at a single device (with the single device being responsible for distributing signals to the other devices for performing the user input). For example, the HIPD 642 can operate an application for generating the first MR game environment 620 and provide the MR device 632 with corresponding data for causing the presentation of the first MR game environment 620, as well as detect the movements of the user 602 (while holding the HIPD 642) to cause the performance of corresponding actions within the first MR game environment 620. Additionally or alternatively, in some embodiments, operational data (e.g., sensor data, image data, application data, device data, and/or other data) of one or more devices is provided to a single device (e.g., the HIPD 642) to process the operational data and cause respective devices to perform an action associated with processed operational data.

In some embodiments, the user 602 can wear a wrist-wearable device 626, wear an MR device 632, wear smart textile-based garments 638 (e.g., wearable haptic gloves), and/or hold an HIPD 642 device. In this embodiment, the wrist-wearable device 626, the MR device 632, and/or the smart textile-based garments 638 are used to interact within an MR environment (e.g., any AR or MR system described above in reference to FIGS. 6A-6B). While the MR device 632 presents a representation of an MR game (e.g., a first MR game environment 620) to the user 602, the wrist-wearable device 626, the MR device 632, and/or the smart textile-based garments 638 detect and coordinate one or more user inputs to allow the user 602 to interact with the MR environment.

In some embodiments, the user 602 can provide a user input via the wrist-wearable device 626, an HIPD 642, the MR device 632, and/or the smart textile-based garments 638 that causes an action in a corresponding MR environment. In some embodiments, each device uses respective sensor data and/or image data to detect the user input and provide an accurate representation of the motion. While four different input devices are shown (e.g., a wrist-wearable device 626, an MR device 632, an HIPD 642, and a smart textile-based garment 638) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 638) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 638 can be used in conjunction with an MR device and/or an HIPD 642. Additionally, the smart textile-based garments 638 can be used in conjunction with an MR device and/or a wrist-wearable device 626 (shown in FIG. 6D-1).

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a separate set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 6A-6C-2 provided above are intended to augment the description provided in reference to FIGS. 1A to 5. While terms in the following description may not be identical to terms used in the foregoing description, a person having ordinary skill in the art would understand these terms to have the same meaning.

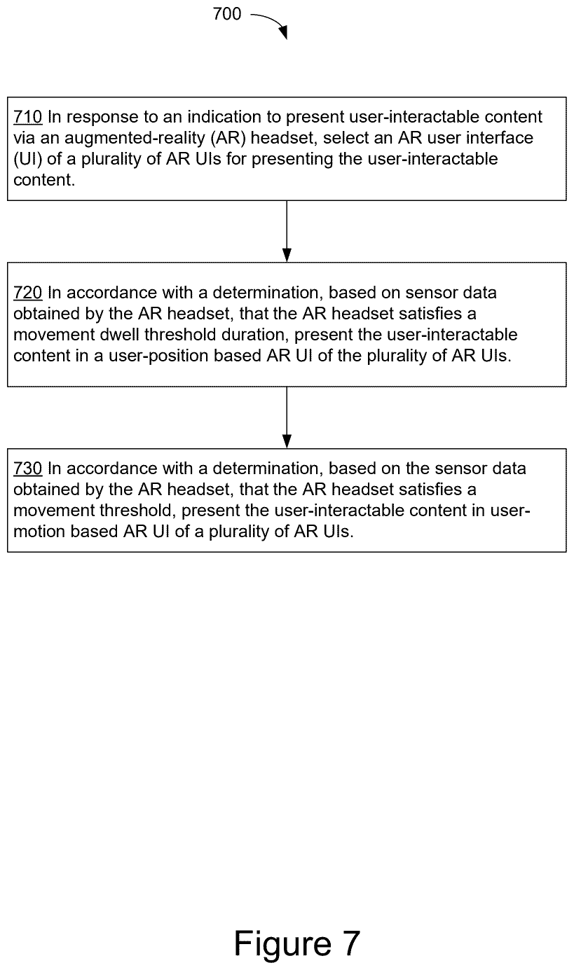

FIG. 7 shows an example method flow chart for selecting one of a plurality of different sets of AR UIs for present user-interactable content to the user, in accordance with some embodiments. Operations of a method 700 represented by the example method flow chart in FIG. 7 can be performed by one or more processors (e.g., central processing units and/or MCUs) of a system such as the first AR system 600a.
(A1) The method 700 includes, in response to an indication to present user-interactable content (e.g., content associated with a particular AR application) via an augmented-reality (AR) headset, selecting (710) an AR user interface (UI) of a plurality of AR UIs for presenting the user-interactable content. For example, in FIG. 1A, the AR device 628 causes presentation of user-interactable content presented within the AR UIs 104-1 and 104-2.

The method 700 includes, in accordance with a determination, based on sensor data obtained by the AR headset (e.g., via sensors of the AR headset or a different device in electronic communication with the AR headset), that the AR headset satisfies a dwell threshold duration (e.g., three seconds) presenting (720) the user-interactable content in a user-position based AR UI of the plurality of AR UIs. As described herein, a user-position based AR UI is configured to be centered around a user's stationary position. For example, the user-position based AR UIs 104-1 and 104-2 may be presented in FIG. 1A based on a determination that the user has remained in a particular position for three seconds. In some embodiments, other factors besides the dwell threshold duration, such as whether the user 602 is sitting in a chair and/or if there is a suitable workspace in front of the user 602.

The method 700 includes, in accordance with another determination, distinct from the determination, based on other sensor data obtained by the AR headset, that the AR headset satisfies a movement threshold, presenting (730) the user-interactable content in a user-motion based AR UI (e.g., a head-leashed AR display mode) of a plurality of AR UIs. For example, as a result of the user 602 transitioning from a sitting to a moving position in FIGS. 1C to 1E, the user-interactable content is switched to be presented as user-motion based AR UI 120 in FIG. 1E. As described herein, a user-motion based AR UI is configured to move while a user moves through space (e.g., changes their head position and/or gaze direction, which may be detected with or without eye-tracking).
(A2) In some embodiments of A1, the method 700 further includes, while presenting the user-interactable content in the user-position based AR UI of the plurality of AR UIs, in accordance with a determination, based on the sensor data obtained by the AR headset, that the AR headset satisfies the movement threshold: (i) ceasing to present the user-interactable content in the user-position based AR UI of the plurality of AR UIs, and (ii) presenting the user-interactable content in the user-motion based AR UI of a plurality of AR UIs.
(A3) In some embodiments of A1 or A2, the method 700 further includes, while presenting the user-interactable content in the user-position based AR UI of the plurality of AR UIs: (i) obtaining information indicating that the user is moving and/or changing a field of view that they are focusing on (e.g., IMU data indicating that the user 602 is standing up, as shown in FIG. 1D), and (ii) in accordance with obtaining the information indicating the moving and/or the changing field of view, adjusting presentation of the user-motion based AR UI such that correspondence is maintained between the user-motion based AR UI and a current field of view of the user. In other words, the AR content becomes head-locked to a particular point with respect to a landmark of the user's head.
(A4) In some embodiments of A3, the method 700 further includes in accordance with obtaining the information indicating the moving and/or the changing field of view, determining a velocity of the moving and/or the changing field of view. The method 700 further includes determining whether the velocity surpasses a soft-leashing threshold velocity. In some embodiments, the soft-leashing threshold velocity is specifically defined based on rotation of the user's head or changes in the gaze direction. The method 700 further includes, in accordance with determining that the velocity surpasses the soft-leashing threshold velocity, causing the user-motion based AR UI to have an adjusted correspondence that includes a delay between when (i) the moving and/or the changing field of view and (ii) the user-motion based AR UI returns to a user-motion based display location. For example, if the user moves their head quickly in a particular direction, the user-motion based AR UI may be caused to visibly trail the user's field of view, and remain closer to where the field of view was directed previously. For example, while the user 602 is moving as shown in FIG. 1E, the AR device 628 can determine whether a movement of the user surpasses the soft-leashing threshold velocity.
(A5) In some embodiments of A3 or A4, the particular location within the field of view of the user is adjustable, within a user-motion based AR UI boundary area. For example, in FIG. 1E, the user-motion based AR UI 120 is presented at a particular location within a head-leashing guidance UI element 122. In some embodiment the user 602 can perform a gesture and/or another input operation to move the AR content within the user-motion based user interface from a first location in the center of the field of view to a second location within a lower-right corner of the user's field of view.
(A6) In some embodiments of A5, the method 700 includes causing presentation of a head-leashing guidance user interface element, the head-leashing guidance user interface element indicating respective edges of the user-motion based AR UI boundary area (e.g., in the particular presentation mode). For example, FIG. 1E shows the head-leashing guidance UI element 122 being presented so as to surround the user-motion based AR UI 120.
(A7) In some embodiments of any one of A3 to A6, one or more other user interfaces are presented at different respective position-based UI locations of the plurality of position-based UI locations while the AR UI is being presented at the position-based UI location, such that the AR UI is a user interface of a plurality of user interfaces, including the one or more other user interfaces. For example, in FIGS. 1A and 1B, the position-based AR UIs 104-1 and 104-2 are presented at different position-based UI locations. In accordance with some embodiments, the AR UI is selected from the plurality of AR UIs that were displayed at the plurality of position-based UI locations based on the AR UI satisfying one or more head-leashing criteria.
(A8) In some embodiments of any one of A1 to A7, the user-position based AR UI of the plurality of AR UIs includes a set of position-based UI locations (e.g., position-based UI regions), each position-based UI location of the set of position-based UI locations including respective user-interactable content. In some embodiments, the method 700 further includes, in accordance with a determination, based on the sensor data obtained by the AR headset, that the AR headset satisfies the movement threshold: (i) presenting a portion of first user-interactable content within a first position-based UI location of the set of position-based UI locations in the user-motion based AR UI of the plurality of AR UIs, (ii) ceasing to present second user-interactable content within a second position-based UI location of the set of position-based UI locations (e.g., causing the AR UIs to converge into a “stacked deck view” that only displays one of the AR UIs at a time).
(A9) In some embodiments of any one of A1 to A8, the portion of the first user-interactable content in the user-motion based AR UI of the plurality of AR UIs is overlayed (e.g., stacked) over a portion of the second user-interactable content within a second position-based UI location of the set of position-based UI locations. For example, FIGS. 1C and 1D show the interactable AR content of the AR UIs 104-1, 104-2, and 104-3 become overlapping as the AR device 128 transitions to the motion-based AR UI mode.
(A10) In some embodiments of any one of A1 to A9, the method 700 further includes, while the content is being caused to be presented within the user-motion based AR UI, in conjunction with a determination that one or more focused-view criteria are satisfied, presenting additional user interface elements corresponding to the content adjacent to the user-motion based AR UI (e.g., the temporal filtering user interface element 1xx presented below the user-motion based AR UI in FIG. 1E). In some embodiments, in accordance with determining that the one or more focused-view criteria are no longer satisfied, ceasing to present the additional user interface elements corresponding to the content. For example, when the user stops moving after performing the movements illustrated in FIGS. 1C to 1E, the additional user interface elements, such as the temporal filtering user interface element, are presented based on determining that the user is moving below a particular velocity, and has maintain respective gaze directions within a gaze movement threshold. That is, in some embodiments, the presentation of the user-motion based user interface stabilizes and/or becomes more feature rich when the user is focusing on it, and/or oriented for the focused mode (e.g., not moving as fast, not partaking in another physical activity).
(A11) In some embodiments of A1 to A10, the method 700 further includes, while presenting the user-interactable content in the user-position based AR UI of the plurality of AR UIs, in accordance with a determination, based on the sensor data obtained by the AR headset, that the AR headset satisfies the movement dwell threshold time: (i) ceasing to present the user-interactable content in the user-motion based AR UI of a plurality of AR UIs, and (ii) presenting the user-interactable content in the user-position based AR UI of the plurality of AR UIs.
(A12) In some embodiments of A11, the user-interactable content is presented in a position-based UI location of a set of position-based UI locations within the user-position based AR UI of the plurality of AR UIs.
(A13) In some embodiments of A1 to A12, the method 700 further includes storing configurations of the plurality of AR UIs, and presenting a respective AR UI of the plurality of AR UIs includes restoring a respective configuration of the respective AR UI of the plurality of AR UIs.
(A14) In some embodiments of A1 to A13, the user-position based AR UI of the plurality of AR UIs includes a set of position-based UI locations, each position-based UI location of the set of position-based UI locations i) including respective user-interactable content and ii) being positionally fixed with respect to a location of the user (e.g., such that the user moving or changing their field of view does not change the respective locations of the AR UIs).
(A15) In some embodiments A14, the method 700 includes, based on an adjustment of a gaze position of the user, causing a portion of a position-based UI location of the set of position-based UI locations to cease being displayed, in accordance with determining that the portion of the position-based UI location of the set of position-based UI locations is beyond a peripheral threshold of the adjusted gaze position.

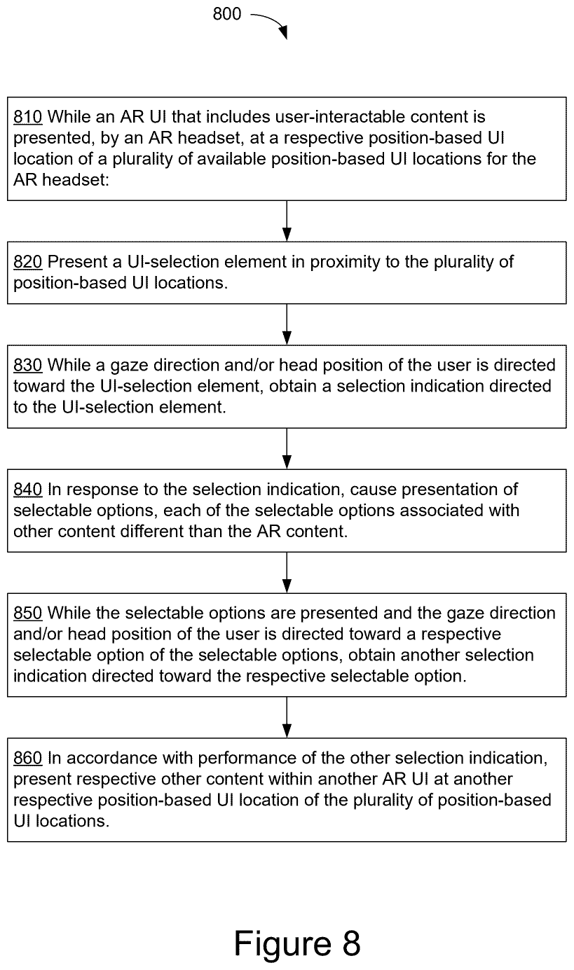

FIG. 8 shows an example method flow chart for presenting a UI-selection element in conjunction with presenting user-interactable content within a set of AR UIs, in accordance with some embodiments. Operations of a method 800 represented by the example method flow chart in FIG. 8 can be performed by one or more processors (e.g., central processing units and/or MCUs) of a system such as the first AR system 600a.

One or more operations of the method 800 occur while an AR UI that includes user-interactable content (e.g., AR application content) is presented, by an AR headset, at a respective position-based UI location of a plurality of available position-based UI locations for the AR headset (810).

While the user-interactable content is presented, the method 800 includes presenting (820) a UI-selection element in proximity to the plurality of position-based UI locations. For example, as shown in FIG. 1A, the position-based UI selection element 108 is presented below the position-based UI location 104-1, in accordance with some embodiments.

The method 800 includes, while a gaze direction and/or head position of the user is directed toward the UI-selection element (e.g., within a threshold angular rotation of a particular position-based UI location), obtaining (830) a selection indication directed to the UI-selection element. In some embodiments, the selection indication is based on the gaze direction and/or head position being directed toward the UI-region-selection element for a particular dwell time. In some embodiments, the selection indication is based on a neuromuscular signal, and/or verbal command obtained from the user.

The method 800 includes, in response to the selection indication, causing (840) presentation of selectable options, each of the selectable options associated with other content different than the AR content (e.g., icons associated with respective applications of the AR content). For example, FIG. 3B shows an AR UI 314-a that includes selectable options associated with different AR content.

The method 800 includes, while the selectable options are presented and the gaze direction and/or head position of the user is directed toward a respective selectable option of the selectable options, obtaining (850) another selection indication directed toward the respective selectable option. For example, in accordance with the user directing a gaze toward a respective selectable option of the plurality of selectable options within the AR UI 314-a, the AR UI 318 can be caused to be presented within the position-based UI location 312-b, as shown in FIG. 3C.

The method 800 includes, in accordance with performance of the other selection indication, presenting (860) respective other content within another AR UI at another respective position-based UI location of the plurality of position-based UI locations (e.g., the AR UI 318).
(B2) In some embodiments of B1, the method 800 further includes, after obtaining the selection indication, while gaze direction and/or the head position has returned to be directed toward the position-based UI selector, obtaining a UI-region-selection indication directed to a position-based UI selector of the position-based AR UI (e.g., the position-based UI selector 110-1 of the position-based AR UI 104-1 in FIG. 1A). In some embodiments, the method 800 further includes, in accordance with obtaining the UI-region-selection indication directed to the position-based UI selector, causing the respective other content to be presented at a different position-based UI location of the plurality of position-based UI locations.
(B3) In some embodiments of B1 or B2, the method 800 further includes determining that the other selection indication is maintained while the user performs a maintained gesture (e.g., a drag gesture) to move a representation of the respective other content to the other respective position-based UI location of the plurality of position-based UI locations. For example, the user 602 performs the gesture 316 in FIG. 3C to move the AR UI 318 from the position-based UI location 312-b to the other position-based UI location 312-c.
(B4) In some embodiments of any one of B1 to B3, the other position-based UI location is the position-based UI location, and the content that had previously been presented at the position-based UI location by the AR UI is replaced by the respective other content.
(B5) In some embodiments of B4, the method 800 further includes, in accordance with the respective other content being presented at the position-based UI location, storing information related to the content (e.g., an application associated with the AR content), where the stored information indicates that the content has been presented at the position-based UI location.
(B6) In some embodiments of B5, the stored information includes AR configuration information indicating configuration aspects for one or more user interface elements of the AR UI. For example, the AR configuration information can include a filter that had been applied by a filtering user interface element of the AR UI.
(B7) In some embodiments of any one of B1 to B6, the method 800 includes presenting an augment-viewer user interface element adjacent to respective content being presented at the position-based UI location. And the method 800 includes, based on obtaining a user selection of the augment-viewer user interface element, presenting an augment-switcher user interface that includes representations of a plurality of AR UIs that have been presented at the position-based UI location (e.g., based on stored information about AR UIs that have been presented at the position-based UI location). In some embodiments, in response to a user input directed to a respective augment adjuster user interface element corresponding to a respective position-based UI location, causing different AR content that has previously been presented at the position-based UI location.
(B8) In some embodiments of B7, the representations of the plurality of AR UIs are presented in a stacked view user interface element, and the representations are ordered in chronological order based on a timing of when the respective user interface elements were presented at the position-based UI location.

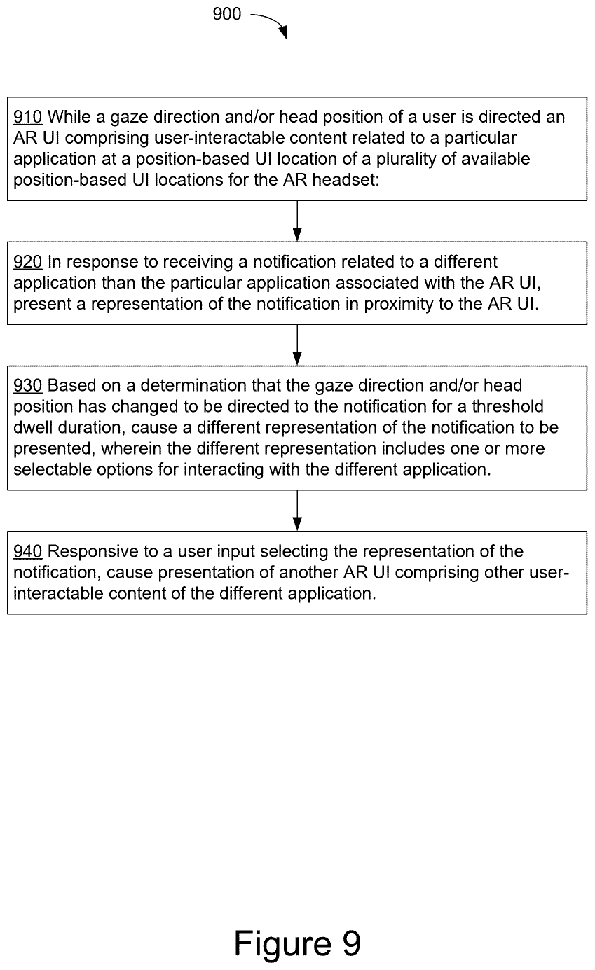

FIG. 9 shows an example method flow chart for progressively surfacing aspects of notifications based on detecting that a user is directing attention to a notification element presented adjacent to other user-interactable content, in accordance with some embodiments. Operations of a method 900 represented by the example method flow chart in FIG. 9 can be performed by one or more processors (e.g., central processing units and/or MCUs) of a system such as the first AR system 600a.
(C1) The method 900 occurs while a gaze direction and/or head position of a user is directed toward an AR UI that includes user-interactable content related to a particular application at a position-based UI location of a plurality of available position-based UI locations for the AR headset (910). For example, in FIG. 2A, the user 602 is initially directing focus to the AR UI 204.

The method 900 includes, in response to receiving a notification related to a different application than the particular application associated with the AR UI, presenting (920) a representation of the notification in proximity to the AR UI. For example, FIG. 2B shows the notification indication 212 presented in proximity to the position-based UI location 207 in FIG. 2B.

The method 900 includes, based on a determination that the gaze direction and/or head position has changed to be directed to the notification for a threshold dwell duration (e.g., away from the AR content being presented at the position-based UI location), causing (930) a different representation of the notification to be presented, wherein the different representation includes one or more selectable options for interacting with the different application. For example, in FIG. 2C, a representation 214 is presented instead of the notification indication 212.

The method 900 includes, responsive to a user input selecting the representation of the notification, causing (940) presentation of another AR UI comprising other user-interactable content of the different application. In some embodiments, a determination whether the other AR content replaces the AR content at the particular position-based UI location, or is presented at a different position-based UI location, is based on a presentation mode that is currently being implemented at the AR device.
(C2) In some embodiments of C1, the method 900 further includes, in accordance with selection of the representation of the notification, causing presentation of the other AR UI at a respective position-based UI location of the plurality of position-based UI locations.
(C3) In some embodiments of C2, the method 900 further includes, while the user is performing the user input directed to the portion of the other content, presenting a preview user interface element that includes a representation of the other AR UI that will be presented at the other particular position-based UI location based on completing the user input.
(C4) In some embodiments of C2 or C3, the method 900 further includes, in accordance with causing presentation of the other AR UI at the respective position-based UI location, causing presentation of application-specific user interface elements for interacting with the other AR UI.
(C5) In some embodiments of any one of C1 to C4, the method 900 further includes, based on determining that the gaze direction of the user is directed to the notification, and away from the AR UI, for a threshold look-away time (e.g., two seconds), ceasing to present the AR UI at the position-based UI location.

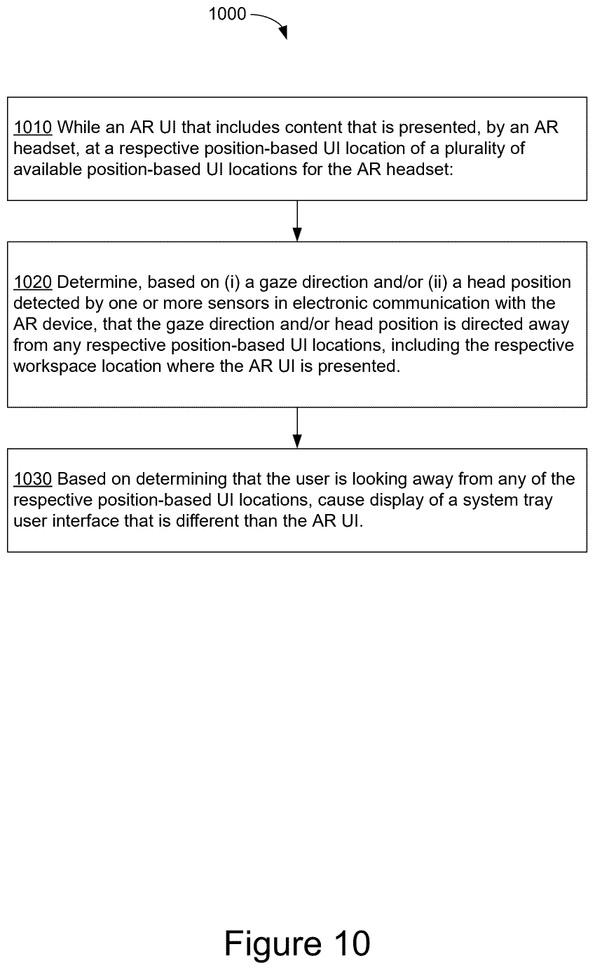

FIG. 10 shows an example method flow chart for presenting a system-level UI element presented adjacent to a plurality of AR UIs presenting application-level interactable AR content, in accordance with some embodiments. Operations (e.g., steps) of a method 1000 represented by the example method flow chart can be performed by one or more processors (e.g., central processing unit and/or MCU) of a system such as the first AR system 600a. At least some of the operations shown in FIG. 10 correspond to instructions stored in a computer memory or computer-readable storage medium (e.g., storage, RAM, and/or memory). Operations of the method 1000 can be performed by a single device alone or in conjunction with one or more processors and/or hardware component of another communicatively coupled device (e.g., the computing system 100) and/or instructions stored in memory or computer-readable medium of the other device coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by one or more particular components or devices, but should not be construed as limiting the performance of the operation to the particular device in all embodiments.
(D1) The method 1000 occurs while an AR UI includes content that is presented, by an AR headset, at a respective position-based UI location of a plurality of available position-based UI locations for the AR headset (1010).

The method 1000 includes determining (1020), based on (i) a gaze direction and/or (ii) a head position detected by one or more sensors in electronic communication with the AR device, that the gaze direction and/or head position is directed away from any respective position-based UI locations, including the respective position-based UI location where the AR UI is presented.

The method 1000 includes, based on determining that the user is looking away from any of the respective position-based UI locations, causing (1030) display of a system tray user interface that is different than the AR UI.
(D2) In some embodiments of D1, the causing display of the system tray user interface is further based on a gaze direction and/or head position being directed toward a particular location associated with the system tray user interface (e.g., a look away region).
(D3) In some embodiments of D1 or D2, the system tray user interface includes one or more first user interface elements for interacting with the content being presented at the AR UI at the particular position-based UI location. In some embodiments, the system tray user interface includes one or more second user interface elements for interacting with a system component of the AR headset. In some embodiments, the system tray user interface includes one or more third user interface elements for interacting with different content associated with a different AR UI.
(D4) In some embodiments of D3, the one or more first user interface elements include a respective first user interface element including a preview of content being presented at the particular position-based UI location (e.g., a “now playing” indicator indicating an amount of progress through the content being presented by the AR UI).
(D5) In some embodiments of D3 or D4, the method 1000 further includes, while the system tray user interface is being presented by the AR headset, responsive to a user input directed to the third user interface element for interacting with the different content associated with the different AR UI, causing display of additional selectable options for interacting with the different content.
(D6) In some embodiments of any one of D3 to D5, the method 1000 further includes, responsive to a user input directed to a respective third user interface element of the one or more third user interface elements, causing performance of an action at another application associated with the different content without presenting any AR UI elements associated with the different content.
(D7) In some embodiments, of any one of D1 to D6, the different AR UI is not being presented at any respective position-based UI locations of the plurality of position-based UI locations.
(E1) In accordance with some embodiments, a system that includes one or more wrist wearable devices and a pair of augmented-reality glasses, and the system is configured to perform operations corresponding to any of A1-D7.
(F1) In accordance with some embodiments, a non-transitory computer readable storage medium including instructions that, when executed by a computing device in communication with a pair of augmented-reality glasses, cause the computer device to perform operations corresponding to any of A1-D7.
(G1) In accordance with some embodiments, a method of operating a pair of augmented-reality glasses, including operations that correspond to any of A1-D7.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method, comprising:
in response to an indication to cause presentation of user-interactable content via an augmented-reality (AR) headset, selecting an AR user interface (UI) of a plurality of AR UIs for presenting the user-interactable content;
in accordance with a determination, based on sensor data obtained by the AR headset, that the AR headset satisfies a dwell threshold time, presenting user-interactable content in a user-position based AR UI of the plurality of AR UIs; and
in accordance with another determination, distinct from the determination, based on other sensor data obtained by the AR headset, that the AR headset satisfies a movement threshold time, presenting the user-interactable content in a user-motion based AR UI of a plurality of AR UIs.

2. The method of claim 1, comprising:
while presenting the user-interactable content in the user-position based AR UI of the plurality of AR UIs:
in accordance with a determination, based on the sensor data obtained by the AR headset, that the AR headset satisfies the movement threshold time:
ceasing to present the user-interactable content in the user-position based AR UI of the plurality of AR UIs; and
presenting the user-interactable content in the user-motion based AR UI of a plurality of AR UIs.

3. The method of claim 1, comprising:
while presenting the user-interactable content in the user-position based AR UI of the plurality of AR UIs:
obtaining information indicating that the AR headset is moving and/or changing a field of view that they are focusing on; and
in accordance with obtaining the information indicating the moving and/or the changing field of view, adjusting presentation of the user-motion based AR UI such that correspondence is maintained between the user-motion based AR UI and a current field of view of lenses of the AR headset.

4. The method of claim 3, further comprising:
in accordance with obtaining the information indicating the moving and/or the changing field of view, determining a velocity of the moving and/or the changing field of view;
determining whether the velocity surpasses a soft-leashing threshold velocity; and
in accordance with determining that the velocity surpasses the soft-leashing threshold velocity, causing the user-motion based AR UI to have an adjusted correspondence that includes a delay between when (i) the moving and/or the changing field of view and (ii) returning of the user-motion based AR UI to a user-motion based display location.

5. The method of claim 3, wherein a particular location within the field of view where the AR UI maintains correspondence is adjustable, within a user-motion based AR UI boundary area, and the method further comprises:
causing presentation of a head-leashing guidance user interface element, the head-leashing guidance user interface element indicating respective edges of the user-motion based AR UI boundary area.

6. The method of claim 3, wherein:
one or more other user interfaces are presented at different respective position-based UI locations of a plurality of position-based UI locations while the user-interactable content is being presented at the user-position based AR UI, such that the AR UI is a user interface of a plurality of user interfaces, including the one or more other user interfaces; and
the AR UI is selected from the plurality of AR UIs that were displayed at the plurality of position-based UI locations based on the AR UI satisfying one or more head-leashing criteria.

7. The method of claim 1, wherein the user-position based AR UI of the plurality of AR UIs includes a set of position-based UI locations, each position-based AR UI location of the set of position-based AR UI locations including respective user-interactable content, and the method further comprises:
in accordance with a determination, based on the sensor data obtained by the AR headset, that the AR headset satisfies the movement threshold time:
presenting a portion of first user-interactable content within a first position-based UI location of the set of position-based UI locations in the user-motion based AR UI of the plurality of AR UIs, wherein the portion of first user-interactable content in the user-motion based AR UI of the plurality of AR UIs is overlayed over a portion of the second user-interactable content within a second position-based UI location of the set of position-based UI locations, and
ceasing to present second user-interactable content within a second position-based UI location of the set of position-based UI locations.

8. The method of claim 1, further comprising:
while the user-interactable content is being presented within the user-motion based AR UI, in conjunction with a determination that one or more focused-view criteria are satisfied, presenting additional user interface elements corresponding to the content adjacent to the user-motion based AR UI; and
in accordance with determining that the one or more focused-view criteria are no longer satisfied, ceasing to present the additional UI elements corresponding to the user-interactable content.

9. A non-transitory, computer-readable storage medium including executable instructions that, when executed by one or more processors, cause the one or more processors to perform or cause performance of operations for.
in response to an indication to cause presentation of user-interactable content via an AR headset, selecting an AR UI of a plurality of AR UIs for presenting the user-interactable content;
in accordance with a determination, based on sensor data obtained by the AR headset, that the AR headset satisfies a dwell threshold time, presenting user-interactable content in a user-position based AR UI of the plurality of AR UIs; and
in accordance with another determination, distinct from the determination, based on other sensor data obtained by the AR headset, that the AR headset satisfies a movement threshold time, presenting the user-interactable content in a user-motion based AR UI of a plurality of AR UIs.

10. The non-transitory, computer-readable storage medium of claim 9, further comprising:
while presenting the user-interactable content in the user-position based AR UI of the plurality of AR UIs:
in accordance with a determination, based on the sensor data obtained by the AR headset, that the AR headset satisfies the movement threshold time:
ceasing to present the user-interactable content in the user-position based AR UI of the plurality of AR UIs; and
presenting the user-interactable content in the user-motion based AR UI of a plurality of AR UIs.

11. The non-transitory, computer-readable storage medium of claim 9, further comprising:
while presenting the user-interactable content in the user-position based AR UI of the plurality of AR UIs:
obtaining information indicating that the AR headset is moving and/or changing a field of view that they are focusing on; and
in accordance with obtaining the information indicating the moving and/or the changing field of view, adjusting presentation of the user-motion based AR UI such that correspondence is maintained between the user-motion based AR UI and a current field of view of lenses of the AR headset.

12. The non-transitory, computer-readable storage medium of claim 11, further comprising:
in accordance with obtaining the information indicating the moving and/or the changing field of view, determining a velocity of the moving and/or the changing field of view;
determining whether the velocity surpasses a soft-leashing threshold velocity; and
in accordance with determining that the velocity surpasses the soft-leashing threshold velocity, causing the user-motion based AR UI to have an adjusted correspondence that includes a delay between when (i) the moving and/or the changing field of view and (ii) returning of the user-motion based AR UI to a user-motion based display location.

13. The non-transitory, computer-readable storage medium of claim 11, wherein a particular location within the field of view where the AR UI maintains correspondence is adjustable, within a user-motion based AR UI boundary area, and further comprising instructions for:
causing presentation of a head-leashing guidance user interface element, the head-leashing guidance user interface element indicating respective edges of the user-motion based AR UI boundary area.

14. The non-transitory, computer-readable storage medium of claim 11, wherein:
one or more other user interfaces are presented at different respective position-based UI locations of a plurality of position-based UI locations while the user-interactable content is being presented at the user-position based AR UI, such that the AR UI is a user interface of a plurality of user interfaces, including the one or more other user interfaces; and
the AR UI is selected from the plurality of AR UIs that were displayed at the plurality of position-based UI locations based on the AR UI satisfying one or more head-leashing criteria.

15. A head-wearable device, comprising one or more processors, and memory storing instructions that, when executed by the one or more processors, cause operations for:
in response to an indication to cause presentation of user-interactable content via an augmented-reality (AR) headset, selecting an AR user interface (UI) of a plurality of AR UIs for presenting the user-interactable content;
in accordance with a determination, based on sensor data obtained by the AR headset, that the AR headset satisfies a dwell threshold time, presenting user-interactable content in a user-position based AR UI of the plurality of AR UIs; and
in accordance with another determination, distinct from the determination, based on other sensor data obtained by the AR headset, that the AR headset satisfies a movement threshold time, presenting the user-interactable content in a user-motion based AR UI of a plurality of AR UIs.

16. The head-wearable device of claim 15, wherein the memory further comprises instructions for:
while presenting the user-interactable content in the user-position based AR UI of the plurality of AR UIs:
in accordance with a determination, based on the sensor data obtained by the AR headset, that the AR headset satisfies the movement threshold time:
ceasing to present the user-interactable content in the user-position based AR UI of the plurality of AR UIs; and
presenting the user-interactable content in the user-motion based AR UI of a plurality of AR UIs.

17. The head-wearable device of claim 15, wherein the memory further comprises instructions for:
while presenting the user-interactable content in the user-position based AR UI of the plurality of AR UIs:
obtaining information indicating that the AR headset is moving and/or changing a field of view that they are focusing on; and
in accordance with obtaining the information indicating the moving and/or the changing field of view, adjusting presentation of the user-motion based AR UI such that correspondence is maintained between the user-motion based AR UI and a current field of view of lenses of the AR headset.

18. The head-wearable device of claim 17, wherein the memory further comprises instructions for:
in accordance with obtaining the information indicating the moving and/or the changing field of view, determining a velocity of the moving and/or the changing field of view;
determining whether the velocity surpasses a soft-leashing threshold velocity; and
in accordance with determining that the velocity surpasses the soft-leashing threshold velocity, causing the user-motion based AR UI to have an adjusted correspondence that includes a delay between when (i) the moving and/or the changing field of view and (ii) returning of the user-motion based AR UI to a user-motion based display location.

19. The head-wearable device of claim 17, wherein a particular location within the field of view where the AR UI maintains correspondence is adjustable, within a user-motion based AR UI boundary area, and the memory further comprises instructions for:
causing presentation of a head-leashing guidance user interface element, the head-leashing guidance user interface element indicating respective edges of the user-motion based AR UI boundary area.

20. The head-wearable device of claim 17, wherein:
one or more other user interfaces are presented at different respective position-based UI locations of a plurality of position-based UI locations while the user-interactable content is being presented at the user-position based AR UI, such that the AR UI is a user interface of a plurality of user interfaces, including the one or more other user interfaces; and
the AR UI is selected from the plurality of AR UIs that were displayed at the plurality of position-based UI locations based on the AR UI satisfying one or more head-leashing criteria.
